(19) United States
(12) Patent Application Publication
(10) Pub. No.: US 2024/0336710 A1
(43) Pub. Date: Oct. 10, 2024

(54) PROCESSES FOR PRODUCING REACTION PRODUCTS

(71) Applicant: The Lubrizol Corporation, Wickliffe, OH (US)

(72) Inventors: Philip W. Pike, Concord Township, OH (US); Dixit Parmar, Long Eaton (GB); Nicolas Proust, Painesville, OH (US); Binbin Guo, Sagamore Hills, OH (US); John R. Johnson, Bainbridge Township, OH (US); Amy L. Short, Lakewood, OH (US); Allison M. Williamson, Chardon, OH (US); Joshua Armbrecht, Wickliffe, OH (US); Patrick Newby, Mentor, OH (US); Kurt F. Wollenberg, Chardon, OH (US)

(21) Appl. No.: 18/681,333

(22) PCT Filed: Aug. 5, 2022
(86) PCT No.: PCT/US22/39500

§ 371 Date: Feb. 5, 2024

Related U.S. Application Data
(60) Provisional application No. 63/230,098, filed on Aug. 6, 2021.

(51) Int. Cl. C08F 8/10

(52) U.S. Cl. CPC C08F 8/10

(57) ABSTRACT

Provided is a process for producing a reaction product, the process comprising reacting polyisobutylene with a radical initiator and an ethylenically unsaturated acylating agent at a reaction temperature of from 150° C. to 225° C. to produce the reaction product, wherein the polyisobutylene is brought to the reaction temperature prior to addition of the radical initiator; and wherein the ethylenically unsaturated acylating agent is added at any time prior to or during addition of the radical initiator.

The disclosed technology relates to processes for producing reaction products of the reaction of polyisobutylene with an initiator and acylating agent.

Acylated polyisobutylenes, such as polyisobutylene succinic anhydrides/acids (“PIBSA”), are used as chemical intermediates in producing a vast number of chemical compositions. As used herein, the terms “polyisobutylene succinic anhydride”, “polyisobutylene succinic acid”, “polyisobutylene succinic anhydride/acid”, and/or “PIBSA” mean any molecule (or composition comprising such molecules) which includes a polyisobutylene portion bonded (directly or indirectly) to a succinic anhydride/acid unit.

Known methods for producing PIBSA may require hazardous chemicals, high temperatures, long reaction times, and/or high energy demands, and may result in by-products and/or impurities (resulting in poor color and/or dark specks/resins, which may require filtration of the product) which reduce the possible markets for the products and/or require undesirable reaction equipment maintenance.

For example, polyisobutylene which contains high levels of tri- and tetra-substituted olefin end groups may be reacted with maleic anhydride in the presence of chlorine to form a desired PIBSA product. The drawbacks of this process include the need to use chlorine as a promoter, which often leads to some incorporation of chlorine into the final PIBSA product, and the formation of insoluble colored impurities in the product. The formation of these insoluble impurities impacts the manufacturing throughput as these solids can agglomerate within the reaction tanks, which results in increased maintenance down time in order to clean reactor tanks to remove these insoluble solids.

As another example, polyisobutylene that contains high levels of terminal vinylidene olefin end groups may be reacted with maleic anhydride in the presence of heat to form a desired PIBSA product. In a commercial manufacturing facility, this transformation has several drawbacks, including high reaction temperatures which are required to form the desired product, long reaction times, and the potential to promote decomposition of the acylating agent prior to the desired reaction taking place. One undesired side effect of these processing conditions is that the products can become visibly colored (typically orange/light brown).

One alternative to these illustrative approaches includes reacting high vinylidene polyisobutylene with maleic anhydride at lower reaction temperatures in the presence of a radical initiator. U.S. Pat. No. 5,112,507 teaches that high vinylidene polyisobutylene reacted with maleic anhydride in the presence of a radical initiator and reaction solvent forms a PIBSA product that is different in structure both from the PIBSA formed by the thermal process and PIBSA prepared by the chlorination process. Under certain reaction conditions, highly reactive polyisobutylene and maleic anhydride form an alternating copolymer where a monomeric unit is represented by the following general formula:

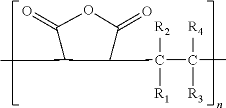

The degree of polymerization is represented by n, and indicates the number of repeat units present in the copolymer. Reaction temperatures were influenced by solvent selection, as most reactions were run at the reflux temperature for the solvent indicated. Reactions were run between 40° C. and 140° C.

U.S. Pat. Nos. 5,565,528 and 5,616,668 teach that the desired reaction products can be formed in the absence of solvent at slightly higher reaction temperatures than those taught in U.S. Pat. No. 5,112,507. However, long reaction times can promote color formation in the product, and reduces manufacturing throughput on the commercial production scale.

The disclosed technology, therefore, provides a process for producing PIBSA which provides improvements in at least one of the above-mentioned shortcomings of known processes, and may provide more desirable PIBSA reaction products, perhaps resulting in higher quality reaction products and/or reduced reaction equipment maintenance. For example, the subject matter described herein may allow production of PIBSA product at significantly reduced time cycles and/or may minimize the undesired maleic anhydride decomposition that can lead to the formation of colored impurities.

The subject matter disclosed herein provides a process for producing a reaction product, the process comprising reacting polyisobutylene (such as high-vinylidene polyisobutylene) with a radical initiator and an ethylenically unsaturated acylating agent at a reaction temperature of from 150° C. to 225° C. to produce the reaction product, wherein the polyisobutylene is brought to the reaction temperature prior to addition of the radical initiator; and wherein the ethylenically unsaturated acylating agent is added at any time prior to or during addition of the radical initiator. In certain embodiments, the ethylenically unsaturated acylating agent may be combined with the polyisobutylene at the beginning of the process. In certain embodiments, the ethylenically unsaturated acylating agent may be combined with the radical initiator for addition to the polyisobutylene after the polyisobutylene is brought to the reaction temperature. In certain embodiments, provided is a process for producing a reaction product, the process comprising reacting polyisobutylene (such as high-vinylidene polyisobutylene) with a radical initiator and an ethylenically unsaturated acylating agent at a reaction temperature of from 150° C. to 225° C. to produce the reaction product, wherein the polyisobutylene is brought to the reaction temperature prior to addition of the radical initiator and the ethylenically unsaturated acylating agent.

As used herein, the term “high-vinylidene polyisobutylene” means a compound including at least 55 (such as at 60, at least 65, at least 70, at least 75, or at least 80) weight percent alpha-methyl-vinylidene polyisobutylene. In certain embodiments, the high-vinylidene polyisobutylene may comprise from 55 to 80 (such as from 55 to 75, from 55 to 70, from 55 to 65, from 55 to 60, from 60 to 80, from 60 to 75, from 60 to 70, from 60 to 65, from 65 to 80, from 65 to 75, from 65 to 70, from 70 to 80, from 70 to 75, or from 75 to 80) weight percent alpha-methyl-vinylidene polyisobutylene. High vinylidene polyisobutylenes are well known, are known to be highly reactive relative to other polyisobutylenes, and are useful as chemical intermediates in numerous chemical synthesis processes.

Also provided is a process for producing a reaction product, the process comprising reacting polyisobutylene (such as high-vinylidene polyisobutylene) with a radical initiator and an ethylenically unsaturated acylating agent in two or more additions at a temperature of from 150° C. to 225° C. to produce the reaction product.

Also provided is a process for producing a reaction product, the process comprising reacting polyisobutylene (such as high-vinylidene polyisobutylene) with a radical initiator and an ethylenically unsaturated acylating agent in two or more additions at a reaction temperature of from 150° C. to 225° C. to produce the reaction product, wherein each of the two or more additions comprises at least 5 weight percent of the total amount of the radical initiator and/or at least 5 weight percent of the total amount of the ethylenically unsaturated acylating agent to be reacted with the polyisobutylene.

Also provided is a process for producing a reaction product, the process comprising reacting polyisobutylene (such as high-vinylidene polyisobutylene) with a radical initiator and an ethylenically unsaturated acylating agent in two or more additions at a reaction temperature of from 150° C. to 225° C. to produce the reaction product, wherein each of the two or more additions are separated in time by at least twice the half-life of the radical initiator.

Also provided is a process for producing a reaction product, the process comprising: reacting polyisobutylene (such as high-vinylidene polyisobutylene) with a radical initiator and an ethylenically unsaturated acylating agent in two or more additions at a reaction temperature of from 150° C. to 225° C. to produce the reaction product; wherein each of the two or more additions comprises at least 5 weight percent of the total amount of the radical initiator and/or at least 5 weight percent of the total amount of the ethylenically unsaturated acylating agent to be reacted with the polyisobutylene; and wherein each of the two or more additions are separated in time by at least twice the half-life of the radical initiator.

Also provided is a process for producing a reaction product, the process comprising: reacting polyisobutylene (such as high-vinylidene polyisobutylene) with a radical initiator and an ethylenically unsaturated acylating agent at a temperature of from 150° C. to 225° C. to produce the reaction product, wherein the polyisobutylene is brought to the reaction temperature in a continuous reactor, prior to commencing continuous addition of the radical initiator to the polyisobutylene in the continuous reactor; and wherein the ethylenically unsaturated acylating agent is added to the continuous reactor: (i) as a mixture with the polyisobutylene; (ii) as a mixture with the radical initiator; and/or (iii) continuously and separately from either the polyisobutylene or the radical initiator.

As compared with known processes, the processes described herein generally provide lower color reaction products (e.g., free of dark specks/resins without filtration), ability to access a degree of functionality greater than 2, decreased energy consumption, reduced equipment maintenance, and/or decreased reaction times, as will become apparent in the detailed description and examples below.

The following embodiments of the present subject matter are contemplated:
1. A process for producing a reaction product, the process comprising: reacting polyisobutylene with a radical initiator and an ethylenically unsaturated acylating agent at a reaction temperature of from 150° C. to 225° C. to produce the reaction product; wherein the polyisobutylene is brought to the reaction temperature prior to addition of the radical initiator; and wherein the ethylenically unsaturated acylating agent is added at any time prior to or during addition of the radical initiator.
2. The process of embodiment 1, wherein the ethylenically unsaturated acylating agent is combined with the polyisobutylene at the beginning of the process.
3. The process of embodiment 1, wherein the ethylenically unsaturated acylating agent is combined with the radical initiator for addition to the polyisobutylene after the polyisobutylene is brought to the reaction temperature.
4. The process of any one of embodiments 1 to 3, wherein the reaction product comprises less than 15 weight percent of a material comprising two or more polyisobutylene units linked by one or more acylating agent units.
5. The process of any one of embodiments 1 to 4, wherein the polyisobutylene comprises an average of 3 to 56 isobutylene monomeric units per molecule.
6. The process of any one of embodiments 1 to 5, wherein the radical initiator comprises an organic peroxide initiator or a peracid initiator.
7. The process of embodiment 6, wherein the organic peroxide initiator comprises diglutaroyl, dilauroyl peroxide, benzoyl peroxide, dicumyl peroxide, di(tert butyl) peroxide, tertbutyl hydroperoxide, 3,4-dimethyl-3,4-diphenyl-hexane, tert-butylperoxy-2-ethylhexanoate, tert-butylperoxy-benzoate, tert-butylperoxy-pivalate, tert-butylperoxy-3,5,5-trimethyl-hexanoate, di(2,4-dichlorobenzoyl) peroxide, di(2-methylbenzoyl) peroxide, or di(4-tert-butylcyclohexyl) peroxydicarbonate.
8. The process of any one of embodiments 1 to 7, wherein the ethylenically unsaturated acylating agent comprises maleic acid, fumaric acid, itaconic acid, mesaconic acid, methylenemalonic acid, citraconic acid, maleic anhydride, itaconic anhydride, citraconic anhydride, or methylenemalonic anhydride.
9. The process of any one of embodiments 1 to 8, wherein the reaction product comprises at least one compound of the following general formula I:

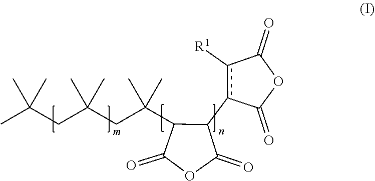

wherein: each R¹ independently represents: —(CH₂)—(C(CH₂))—CH₃); H; or is not present; wherein when R¹ is not present, the dashed double bond represents a double bond, and when R¹ is present, the dashed double bond represents a single bond; each m independently is an integer from 1 to 52; and each n independently is 0, 1 or 2.
10. The process of any one of embodiments 1 to 9, wherein the reaction product comprises at least 30 mol % of the at least one compound of the general formula I.
11. The process of any one of embodiments 1 to 10, wherein the reaction product comprises less than 40 weight percent unreacted polyisobutylene.
12. A composition comprising the reaction product of the process of any one of embodiments 1 to 11.

Various features and embodiments of the present subject matter will be described below by way of non-limiting illustration.

The amount of each chemical component described herein is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

As used herein, the indefinite article “a”/“an” is intended to mean one or more than one. As used herein, the phrase “at least one” means one or more than one of the following terms. Thus, “a”/“an” and “at least one” may be used interchangeably. For example “at least one of A, B or C” means that just one of A, B or C may be included, and any mixture of two or more of A, B and C may be included, in alternative embodiments.

As used herein, the term “substantially” means that a value of a given quantity is within ±10% of the stated value. In other embodiments, the value is within ±5% of the stated value. In other embodiments, the value is within ±2.5% of the stated value. In other embodiments, the value is within ±1% of the stated value.

As used herein, the term “substantially free of” means that a component does not include any intentional addition or intentional creation of the material which the component is “substantially free of”. For example, the component may include a material which the component is “substantially free of” at no more than impurity levels, which may be the result of incomplete chemical reactions and/or unintended/undesired (but perhaps unavoidable) reaction products.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

Provided is a process for producing a reaction product, the process comprising reacting polyisobutylene (such as high-vinylidene polyisobutylene) with a radical initiator and an ethylenically unsaturated acylating agent at a reaction temperature of from 150° C. to 225° C. to produce the reaction product, wherein the polyisobutylene is brought to the reaction temperature prior to addition of the radical initiator; and wherein the ethylenically unsaturated acylating agent is added at any time prior to or during addition of the radical initiator. Without wishing to be limited by theory, it is believed that undesirable reaction products are significantly reduced, or perhaps even eliminated, by bringing the polyisobutylene up to the reaction temperature prior to adding the radical initiator. Such undesirable reaction products are discussed above.

In certain embodiments, the ethylenically unsaturated acylating agent may be combined with the polyisobutylene at the beginning of the process. In certain embodiments, the ethylenically unsaturated acylating agent may be combined with the radical initiator for addition to the polyisobutylene after the polyisobutylene is brought to the reaction temperature. In certain embodiments, provided is a process for producing a reaction product, the process comprising reacting polyisobutylene (such as high-vinylidene polyisobutylene) with a radical initiator and an ethylenically unsaturated acylating agent at a reaction temperature of from 150° C. to 225° C. to produce the reaction product, wherein the polyisobutylene is brought to the reaction temperature prior to addition of the radical initiator and the ethylenically unsaturated acylating agent.

In certain embodiments, the reaction temperature is from 155° C. to 225° C., from 160° C. to 225° C., from 165° C. to 225° C., from 166° C. to 225° C., from 167° C. to 225° C., from 168° C. to 225° C., from 169° C. to 225° C., from 170° C. to 225° C., from 171° C. to 225° C., from 172° C. to 225° C., from 173° C. to 225° C., from 174° C. to 225° C., from 175° C. to 225° C., from 150° C. to 220° C., from 155° C. to 220° C., from 160° C. to 220° C., from 165° C. to 220° C., from 166° C. to 220° C., from 167° C. to 220° C., from 168° C. to 220° C., from 169° C. to 220° C., from 170° C. to 220° C., from 171° C. to 220° C., from 172° C. to 220° C., from 173° C. to 220° C., from 174° C. to 220° C., from 175° C. to 220° C., from 150° C. to 215° C., from 155° C. to 215° C., from 160° C. to 215° C., from 165° C. to 215° C., from 166° C. to 215° C., from 167° C. to 215° C., from 168° C. to 215° C., from 169° C. to 215° C., from 170° C. to 215° C., from 171° C. to 215° C., from 172° C. to 215° C., from 173° C. to 215° C., from 174° C. to 215° C., from 175° C. to 215° C., from 150° C. to 210° C., from 155° C. to 210° C., from 160° C. to 210° C., from 165° C. to 210° C., from 166° C. to 210° C., from 167° C. to 210° C., from 168° C. to 210° C., from 169° C. to 210° C., from 170° C. to 210° C., from 171° C. to 210° C., from 172° C. to 210° C., from 173° C. to 210° C., from 174° C. to 210° C., from 175° C. to 210° C., from 150° C. to 205° C., from 155° C. to 205° C., from 160° C. to 205° C., from 165° C. to 205° C., from 166° C. to 205° C., from 167° C. to 205° C., from 168° C. to 205° C., from 169° C. to 205° C., from 170° C. to 205° C., from 171° C. to 205° C., from 172° C. to 205° C., from 173° C. to 205° C., from 174° C. to 205° C., from 175° C. to 205° C., from 150° C. to 200° C., from 155° C. to 200° C., from 160° C. to 200° C., from 165° C. to 200° C., from 166° C. to 200° C., from 167° C. to 200° C., from 168° C. to 200° C., from 169° C. to 200° C., from 170° C. to 200° C., from 171° C. to 200° C., from 172° C. to 200° C., from 173° C. to 200° C., from 174° C. to 200° C., from 175° C. to 200° C., from 150° C. to 195° C., from 155° C. to 195° C., from 160° C. to 195° C., from 165° C. to 195° C., from 166° C. to 195° C., from 167° C. to 195° C., from 168° C. to 195° C., from 169° C. to 195° C., from 170° C. to 195° C., from 171° C. to 195° C., from 172° C. to 195° C., from 173° C. to 195° C., from 174° C. to 195° C., from 175° C. to 195° C., from 150° C. to 190° C., from 155° C. to 190° C., from 160° C. to 190° C., from 165° C. to 190° C., from 166° C. to 190° C., from 167° C. to 190° C., from 168° C. to 190° C., from 169° C. to 190° C., from 170° C. to 190° C., from 171° C. to 190° C., from 172° C. to 190° C., from 173° C. to 190° C., from 174° C. to 190° C., from 175° C. to 190° C., from 150° C. to 185° C., from 155° C. to 185° C., from 160° C. to 185° C., from 165° C. to 185° C., from 166° C. to 185° C., from 167° C. to 185° C., from 168° C. to 185° C., from 169° C. to 185° C., from 170° C. to 185° C., from 171° C. to 185° C., from 172° C. to 185° C., from 173° C. to 185° C., from 174° C. to 185° C., from 175° C. to 185° C., from 150° C. to 180° C., from 155° C. to 180° C., from 160° C. to 180° C., from 165° C. to 180° C., from 166° C. to 180° C., from 167° C. to 180° C., from 168° C. to 180° C., from 169° C. to 180° C., from 170° C. to 180° C., from 171° C. to 180° C., from 172° C. to 180° C., from 173° C. to 180° C., from 174° C. to 180° C., from 175° C. to 180° C., from 150° C. to 175° C., from 155° C. to 175° C., from 160° C. to 175° C., from 165° C. to 175° C., from 166° C. to 175° C., from 167° C. to 175° C., from 168° C. to 175° C., from 169° C. to 175° C., from 170° C. to 175° C., from 171° C. to 175° C., from 172° C. to 175° C., from 173° C. to 175° C., from 174° C. to 175° C., from 150° C. to 174° C., from 155° C. to 174° C., from 160° C. to 174° C., from 165° C. to 174° C., from 166° C. to 174° C., from 167° C. to 174° C., from 168° C. to 174° C., from 169° C. to 174° C., from 170° C. to 174° C., from 171° C. to 174° C., from 172° C. to 174° C., from 173° C. to 174° C., from 150° C. to 173° C., from 155° C. to 173° C., from 160° C. to 173° C., from 165° C. to 173° C., from 166° C. to 173° C., from 167° C. to 173° C., from 168° C. to 173° C., from 169° C. to 173° C., from 170° C. to 173° C., from 171° C. to 173° C., from 172° C. to 173° C., from 150° C. to 172° C., from 155° C. to 172° C., from 160° C. to 172° C., from 165° C. to 172° C., from 166° C. to 172° C., from 167° C. to 172° C., from 168° C. to 172° C., from 169° C. to 172° C., from 170° C. to 172° C., from 171° C. to 172° C., from 150° C. to 171° C., from 155° C. to 171° C., from 160° C. to 171° C., from 165° C. to 171° C., from 166° C. to 171° C., from 167° C. to 171° C., from 168° C. to 171° C., from 169° C. to 171° C., from 170° C. to 171° C., from 150° C. to 170° C., from 155° C. to 170° C., from 160° C. to 170° C., from 165° C. to 170° C., from 166° C. to 170° C., from 167° C. to 170° C., from 168° C. to 170° C., or from 169° C. to 170° C.

In certain embodiments, the total amount of radical initiator added during the processes described herein may be from 0.01 to 1 (such as from 0.01 to 0.9, from 0.01 to 0.8, from 0.01 to 0.7, from 0.01 to 0.6, from 0.01 to 0.5, from 0.01 to 0.45, from 0.01 to 0.4, from 0.01 to 0.35, from 0.01 to 0.3, from 0.01 to 0.25, from 0.01 to 0.2, from 0.01 to 0.19, from 0.01 to 0.18, from 0.01 to 0.17, from 0.01 to 0.16, from 0.01 to 0.15, from 0.01 to 0.14, from 0.01 to 0.13, from 0.01 to 0.12, from 0.01 to 0.11, from 0.01 to 0.1, from 0.02 to 0.9, from 0.02 to 0.8, from 0.02 to 0.7, from 0.02 to 0.6, from 0.02 to 0.5, from 0.02 to 0.45, from 0.02 to 0.4, from 0.02 to 0.35, from 0.02 to 0.3, from 0.02 to 0.25, from 0.02 to 0.2, from 0.02 to 0.19, from 0.02 to 0.18, from 0.02 to 0.17, from 0.02 to 0.16, from 0.02 to 0.15, from 0.02 to 0.14, from 0.02 to 0.13, from 0.02 to 0.12, from 0.02 to 0.11, from 0.02 to 0.1, from 0.03 to 0.9, from 0.03 to 0.8, from 0.03 to 0.7, from 0.03 to 0.6, from 0.03 to 0.5, from 0.03 to 0.45, from 0.03 to 0.4, from 0.03 to 0.35, from 0.03 to 0.3, from 0.03 to 0.25, from 0.03 to 0.2, from 0.03 to 0.19, from 0.03 to 0.18, from 0.03 to 0.17, from 0.03 to 0.16, from 0.03 to 0.15, from 0.03 to 0.14, from 0.03 to 0.13, from 0.03 to 0.12, from 0.03 to 0.11, from 0.03 to 0.1, from 0.04 to 0.9, from 0.04 to 0.8, from 0.04 to 0.7, from 0.04 to 0.6, from 0.04 to 0.5, from 0.04 to 0.45, from 0.04 to 0.4, from 0.04 to 0.35, from 0.04 to 0.3, from 0.04 to 0.25, from 0.04 to 0.2, from 0.04 to 0.19, from 0.04 to 0.18, from 0.04 to 0.17, from 0.04 to 0.16, from 0.04 to 0.15, from 0.04 to 0.14, from 0.04 to 0.13, from 0.04 to 0.12, from 0.04 to 0.11, from 0.04 to 0.1, from 0.05 to 0.9, from 0.05 to 0.8, from 0.05 to 0.7, from 0.05 to 0.6, from 0.05 to 0.5, from 0.05 to 0.45, from 0.05 to 0.4, from 0.05 to 0.35, from 0.05 to 0.3, from 0.05 to 0.25, from 0.05 to 0.2, from 0.05 to 0.19, from 0.05 to 0.18, from 0.05 to 0.17, from 0.05 to 0.16, from 0.05 to 0.15, from 0.05 to 0.14, from 0.05 to 0.13, from 0.05 to 0.12, from 0.05 to 0.11, from 0.05 to 0.1, from 0.06 to 0.9, from 0.06 to 0.8, from 0.06 to 0.7, from 0.06 to 0.6, from 0.06 to 0.5, from 0.06 to 0.45, from 0.06 to 0.4, from 0.06 to 0.35, from 0.06 to 0.3, from 0.06 to 0.25, from 0.06 to 0.2, from 0.06 to 0.19, from 0.06 to 0.18, from 0.06 to 0.17, from 0.06 to 0.16, from 0.06 to 0.15, from 0.06 to 0.14, from 0.06 to 0.13, from 0.06 to 0.12, from 0.06 to 0.11, from 0.06 to 0.1, from 0.07 to 0.9, from 0.07 to 0.8, from 0.07 to 0.7, from 0.07 to 0.6, from 0.07 to 0.5, from 0.07 to 0.45, from 0.07 to 0.4, from 0.07 to 0.35, from 0.07 to 0.3, from 0.07 to 0.25, from 0.07 to 0.2, from 0.07 to 0.19, from 0.07 to 0.18, from 0.07 to 0.17, from 0.07 to 0.16, from 0.07 to 0.15, from 0.07 to 0.14, from 0.07 to 0.13, from 0.07 to 0.12, from 0.07 to 0.11, from 0.07 to 0.1, from 0.08 to 0.9, from 0.08 to 0.8, from 0.08 to 0.7, from 0.08 to 0.6, from 0.08 to 0.5, from 0.08 to 0.45, from 0.08 to 0.4, from 0.08 to 0.35, from 0.08 to 0.3, from 0.08 to 0.25, from 0.08 to 0.2, from 0.08 to 0.19, from 0.08 to 0.18, from 0.08 to 0.17, from 0.08 to 0.16, from 0.08 to 0.15, from 0.08 to 0.14, from 0.08 to 0.13, from 0.08 to 0.12, from 0.08 to 0.11, from 0.08 to 0.1, from 0.09 to 0.9, from 0.09 to 0.8, from 0.09 to 0.7, from 0.09 to 0.6, from 0.09 to 0.5, from 0.09 to 0.45, from 0.09 to 0.4, from 0.09 to 0.35, from 0.09 to 0.3, from 0.09 to 0.25, from 0.09 to 0.2, from 0.09 to 0.19, from 0.09 to 0.18, from 0.09 to 0.17, from 0.09 to 0.16, from 0.09 to 0.15, from 0.09 to 0.14, from 0.09 to 0.13, from 0.09 to 0.12, from 0.09 to 0.11, from 0.09 to 0.1, from 0.1 to 0.9, from 0.1 to 0.8, from 0.1 to 0.7, from 0.1 to 0.6, from 0.1 to 0.5, from 0.1 to 0.45, from 0.1 to 0.4, from 0.1 to 0.35, from 0.1 to 0.3, from 0.1 to 0.25, from 0.1 to 0.2, from 0.1 to 0.19, from 0.1 to 0.18, from 0.1 to 0.17, from 0.1 to 0.16, from 0.1 to 0.15, from 0.1 to 0.14, from 0.1 to 0.13, from 0.1 to 0.12, or from 0.1 to 0.11) equivalents, based on the amount of polyisobutylene being reacted.

In certain embodiments, the total amount of ethylenically unsaturated acylating agent added during the processes described herein may be from 0.5 to 3 (such as from 0.5 to 2.9, from 0.5 to 2.8, from 0.5 to 2.7, from 0.5 to 2.6, from 0.5 to 2.5, from 0.5 to 2.4, from 0.5 to 2.3, from 0.5 to 2.4, from 0.5 to 2.3, from 0.5 to 2.2, from 0.5 to 2.1, from 0.5 to 2, from 0.5 to 1.9, from 0.5 to 1.8, from 0.5 to 1.7, from 0.5 to 1.6, from 0.5 to 1.5, from 0.5 to 1.4, from 0.5 to 1.3, from 0.5 to 1.2, from 0.5 to 1.1, from 0.5 to 1, from 0.6 to 3, from 0.6 to 2.9, from 0.6 to 2.8, from 0.6 to 2.7, from 0.6 to 2.6, from 0.6 to 2.5, from 0.6 to 2.4, from 0.6 to 2.3, from 0.6 to 2.4, from 0.6 to 2.3, from 0.6 to 2.2, from 0.6 to 2.1, from 0.6 to 2, from 0.6 to 1.9, from 0.6 to 1.8, from 0.6 to 1.7, from 0.6 to 1.6, from 0.6 to 1.5, from 0.6 to 1.4, from 0.6 to 1.3, from 0.6 to 1.2, from 0.6 to 1.1, from 0.6 to 1, from 0.7 to 3, from 0.7 to 2.9, from 0.7 to 2.8, from 0.7 to 2.7, from 0.7 to 2.6, from 0.7 to 2.5, from 0.7 to 2.4, from 0.7 to 2.3, from 0.7 to 2.4, from 0.7 to 2.3, from 0.7 to 2.2, from 0.7 to 2.1, from 0.7 to 2, from 0.7 to 1.9, from 0.7 to 1.8, from 0.7 to 1.7, from 0.7 to 1.6, from 0.7 to 1.5, from 0.7 to 1.4, from 0.7 to 1.3, from 0.7 to 1.2, from 0.7 to 1.1, from 0.7 to 1, from 0.8 to 3, from 0.8 to 2.9, from 0.8 to 2.8, from 0.8 to 2.7, from 0.8 to 2.6, from 0.8 to 2.5, from 0.8 to 2.4, from 0.8 to 2.3, from 0.8 to 2.4, from 0.8 to 2.3, from 0.8 to 2.2, from 0.8 to 2.1, from 0.8 to 2, from 0.8 to 1.9, from 0.8 to 1.8, from 0.8 to 1.7, from 0.8 to 1.6, from 0.8 to 1.5, from 0.8 to 1.4, from 0.8 to 1.3, from 0.8 to 1.2, from 0.8 to 1.1, from 0.8 to 1, from 0.9 to 3, from 0.9 to 2.9, from 0.9 to 2.8, from 0.9 to 2.7, from 0.9 to 2.6, from 0.9 to 2.5, from 0.9 to 2.4, from 0.9 to 2.3, from 0.9 to 2.2, from 0.9 to 2.1, from 0.9 to 2, from 0.9 to 1.9, from 0.9 to 1.8, from 0.9 to 1.7, from 0.9 to 1.6, from 0.9 to 1.5, from 0.9 to 1.4, from 0.9 to 1.3, from 0.9 to 1.2, from 0.9 to 1.1, from 0.9 to 1, from 1 to 3, from 1 to 2.9, from 1 to 2.8, from 1 to 2.7, from 1 to 2.6, from 1 to 2.5, from 1 to 2.4, from 1 to 2.3, from 1 to 2.2, from 1 to 2.1, from 1 to 2, from 1 to 1.9, from 1 to 1.8, from 1 to 1.7, from 1 to 1.6, from 1 to 1.5, from 1 to 1.4, from 1 to 1.3, from 1 to 1.2, from 1 to 1.1, from 1.1 to 3, from 1.1 to 2.9, from 1.1 to 2.8, from 1.1 to 2.7, from 1.1 to 2.6, from 1.1 to 2.5, from 1.1 to 2.4, from 1.1 to 2.3, from 1.1 to 2.2, from 1.1 to 2.1, from 1.1 to 2, from 1.1 to 1.9, from 1.1 to 1.8, from 1.1 to 1.7, from 1.1 to 1.6, from 1.1 to 1.5, from 1.1 to 1.4, from 1.1 to 1.3, from 1.1 to 1.2, from 1.2 to 3, from 1.2 to 2.9, from 1.2 to 2.8, from 1.2 to 2.7, from 1.2 to 2.6, from 1.2 to 2.5, from 1.2 to 2.4, from 1.2 to 2.3, from 1.2 to 2.2, from 1.2 to 2.1, from 1.2 to 2, from 1.2 to 1.9, from 1.2 to 1.8, from 1.2 to 1.7, from 1.2 to 1.6, from 1.2 to 1.5, from 1.2 to 1.4, from 1.2 to 1.3, from 1.3 to 3, from 1.3 to 2.9, from 1.3 to 2.8, from 1.3 to 2.7, from 1.3 to 2.6, from 1.3 to 2.5, from 1.3 to 2.4, from 1.3 to 2.3, from 1.3 to 2.2, from 1.3 to 2.1, from 1.3 to 2, from 1.3 to 1.9, from 1.3 to 1.8, from 1.3 to 1.7, from 1.3 to 1.6, from 1.3 to 1.5, from 1.3 to 1.4, from 1.4 to 3, from 1.4 to 2.9, from 1.4 to 2.8, from 1.4 to 2.7, from 1.4 to 2.6, from 1.4 to 2.5, from 1.4 to 2.4, from 1.4 to 2.3, from 1.4 to 2.2, from 1.4 to 2.1, from 1.4 to 2, from 1.4 to 1.9, from 1.4 to 1.8, from 1.4 to 1.7, from 1.4 to 1.6, from 1.4 to 1.5, from 1.5 to 3, from 1.5 to 2.9, from 1.5 to 2.8, from 1.5 to 2.7, from 1.5 to 2.6, from 1.5 to 2.5, from 1.5 to 2.4, from 1.5 to 2.3, from 1.5 to 2.2, from 1.5 to 2.1, from 1.5 to 2, from 1.5 to 1.9, from 1.5 to 1.8, from 1.5 to 1.7, from 1.5 to 1.6, from 1.6 to 3, from 1.6 to 2.9, from 1.6 to 2.8, from 1.6 to 2.7, from 1.6 to 2.6, from 1.6 to 2.5, from 1.6 to 2.4, from 1.6 to 2.3, from 1.6 to 2.2, from 1.6 to 2.1, from 1.6 to 2, from 1.6 to 1.9, from 1.6 to 1.8, from 1.6 to 1.7, from 1.7 to 3, from 1.7 to 2.9, from 1.7 to 2.8, from 1.7 to 2.7, from 1.7 to 2.6, from 1.7 to 2.5, from 1.7 to 2.4, from 1.7 to 2.3, from 1.7 to 2.2, from 1.7 to 2.1, from 1.7 to 2, from 1.7 to 1.9, from 1.7 to 1.8, from 1.8 to 3, from 1.8 to 2.9, from 1.8 to 2.8, from 1.8 to 2.7, from 1.8 to 2.6, from 1.8 to 2.5, from 1.8 to 2.4, from 1.8 to 2.3, from 1.8 to 2.2, from 1.8 to 2.1, from 1.8 to 2, from 1.8 to 1.9, from 1.9 to 3, from 1.9 to 2.9, from 1.9 to 2.8, from 1.9 to 2.7, from 1.9 to 2.6, from 1.9 to 2.5, from 1.9 to 2.4, from 1.9 to 2.3, from 1.9 to 2.2, from 1.9 to 2.1, from 1.9 to 2, from 2 to 3, from 2 to 2.9, from 2 to 2.8, from 2 to 2.7, from 2 to 2.6, from 2 to 2.5, from 2 to 2.4, from 2 to 2.3, from 2 to 2.2, from 2 to 2.1, from 2.1 to 3, from 2.1 to 2.9, from 2.1 to 2.8, from 2.1 to 2.7, from 2.1 to 2.6, from 2.1 to 2.5, from 2.1 to 2.4, from 2.1 to 2.3, from 2.1 to 2.2, from 2.2 to 3, from 2.2 to 2.9, from 2.2 to 2.8, from 2.2 to 2.7, from 2.2 to 2.6, from 2.2 to 2.5, from 2.2 to 2.4, from 2.2 to 2.3, from 2.3 to 3, from 2.3 to 2.9, from 2.3 to 2.8, from 2.3 to 2.7, from 2.3 to 2.6, from 2.3 to 2.5, from 2.3 to 2.4, from 2.4 to 3, from 2.4 to 2.9, from 2.4 to 2.8, from 2.4 to 2.7, from 2.4 to 2.6, from 2.4 to 2.5, from 2.5 to 3, from 2.5 to 2.9, from 2.5 to 2.8, from 2.5 to 2.7, or from 2.5 to 2.6) equivalents, based on the amount of polyisobutylene being reacted.

In certain embodiments, the reaction product comprises less than 15 (such as less than 14, 13, 12, 11, 10, 9, 8, 7, 6, 5, 4.5, 4, 3.5, 3, 2.5, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or 0.1) weight percent of a material comprising two or more polyisobutylene units linked by one or more acylating agent units. In certain embodiments, the reaction product is substantially free of a material comprising two or more polyisobutylene units linked by one or more acylating agent units. In certain embodiments, the reaction product comprises from 0 (such as greater than 0) to 15 (such as 14, 13, 12, 11, 10, 9, 8, 7, 6, 5, 4.5, 4, 3.5, 3, 2.5, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, or 0.1) weight percent of a material comprising two or more polyisobutylene units linked by one or more acylating agent units. In certain embodiments, the reaction product comprises from 0 to 15 (such as from 0 to 14, from 0 to 13, from 0 to 12, from 0 to 11, from 0 to 10, from 0 to 9, from 0 to 8, from 0 to 7, from 0 to 6, from 0 to 5, from 0 to 4.5, from 0 to 4, from 0 to 3.5, from 0 to 3, from 0 to 2.5, from 0 to 2, from 0 to 1.9, from 0 to 1.8, from 0 to 1.7, from 0 to 1.6, from 0 to 1.5, from 0 to 1.4, from 0 to 1.3, from 0 to 1.2, from 0 to 1.1, from 0 to 1, from 0 to 0.9, from 0 to 0.8, from 0 to 0.7, from 0 to 0.6, from 0 to 0.5, from 0 to 0.4, from 0 to 0.3, from 0 to 0.2, from 0 to 0.1, from greater than 0 to 15, from greater than 0 to 14, from greater than 0 to 13, from greater than 0 to 12, from greater than 0 to 11, from greater than 0 to 10, from greater than 0 to 9, from greater than 0 to 8, from greater than 0 to 7, from greater than 0 to 6, from greater than 0 to 5, from greater than 0 to 4.5, from greater than 0 to 4, from greater than 0 to 3.5, from greater than 0 to 3, from greater than 0 to 2.5, from greater than 0 to 2, from greater than 0 to 1.9, from greater than 0 to 1.8, from greater than 0 to 1.7, from greater than 0 to 1.6, from greater than 0 to 1.5, from greater than 0 to 1.4, from greater than 0 to 1.3, from greater than 0 to 1.2, from greater than 0 to 1.1, from greater than 0 to 1, from greater than 0 to 0.9, from greater than 0 to 0.8, from greater than 0 to 0.7, from greater than 0 to 0.6, from greater than 0 to 0.5, from greater than 0 to 0.4, from greater than 0 to 0.3, from greater than 0 to 0.2, from greater than 0 to 0.1, from 0.1 to 15, from 0.1 to 14, from 0.1 to 13, from 0.1 to 12, from 0.1 to 11, from 0.1 to 10, from 0.1 to 9, from 0.1 to 8, from 0.1 to 7, from 0.1 to 6, from 0.1 to 5, from 0.1 to 4.5, from 0.1 to 4, from 0.1 to 3.5, from 0.1 to 3, from 0.1 to 2.5, from 0.1 to 2, from 0.1 to 1.9, from 0.1 to 1.8, from 0.1 to 1.7, from 0.1 to 1.6, from 0.1 to 1.5, from 0.1 to 1.4, from 0.1 to 1.3, from 0.1 to 1.2, from 0.1 to 1.1, from 0.1 to 1, from 0.1 to 0.9, from 0.1 to 0.8, from 0.1 to 0.7, from 0.1 to 0.6, from 0.1 to 0.5, from 0.1 to 0.4, from 0.1 to 0.3, from 0.1 to 0.2, from 0.2 to 15, from 0.2 to 14, from 0.2 to 13, from 0.2 to 12, from 0.2 to 11, from 0.2 to 10, from 0.2 to 9, from 0.2 to 8, from 0.2 to 7, from 0.2 to 6, from 0.2 to 5, from 0.2 to 4.5, from 0.2 to 4, from 0.2 to 3.5, from 0.2 to 3, from 0.2 to 2.5, from 0.2 to 2, from 0.2 to 1.9, from 0.2 to 1.8, from 0.2 to 1.7, from 0.2 to 1.6, from 0.2 to 1.5, from 0.2 to 1.4, from 0.2 to 1.3, from 0.2 to 1.2, from 0.2 to 1.1, from 0.2 to 1, from 0.2 to 0.9, from 0.2 to 0.8, from 0.2 to 0.7, from 0.2 to 0.6, from 0.2 to 0.5, from 0.2 to 0.4, from 0.2 to 0.3, from 0.3 to 15, from 0.3 to 14, from 0.3 to 13, from 0.3 to 12, from 0.3 to 11, from 0.3 to 10, from 0.3 to 9, from 0.3 to 8, from 0.3 to 7, from 0.3 to 6, from 0.3 to 5, from 0.3 to 4.5, from 0.3 to 4, from 0.3 to 3.5, from 0.3 to 3, from 0.3 to 2.5, from 0.3 to 2, from 0.3 to 1.9, from 0.3 to 1.8, from 0.3 to 1.7, from 0.3 to 1.6, from 0.3 to 1.5, from 0.3 to 1.4, from 0.3 to 1.3, from 0.3 to 1.2, from 0.3 to 1.1, from 0.3 to 1, from 0.3 to 0.9, from 0.3 to 0.8, from 0.3 to 0.7, from 0.3 to 0.6, from 0.3 to 0.5, from 0.3 to 0.4, from 0.4 to 15, from 0.4 to 14, from 0.4 to 13, from 0.4 to 12, from 0.4 to 11, from 0.4 to 10, from 0.4 to 9, from 0.4 to 8, from 0.4 to 7, from 0.4 to 6, from 0.4 to 5, from 0.4 to 4.5, from 0.4 to 4, from 0.4 to 3.5, from 0.4 to 3, from 0.4 to 2.5, from 0.4 to 2, from 0.4 to 1.9, from 0.4 to 1.8, from 0.4 to 1.7, from 0.4 to 1.6, from 0.4 to 1.5, from 0.4 to 1.4, from 0.4 to 1.3, from 0.4 to 1.2, from 0.4 to 1.1, from 0.4 to 1, from 0.4 to 0.9, from 0.4 to 0.8, from 0.4 to 0.7, from 0.4 to 0.6, from 0.4 to 0.5, from 0.5 to 15, from 0.5 to 14, from 0.5 to 13, from 0.5 to 12, from 0.5 to 11, from 0.5 to 10, from 0.5 to 9, from 0.5 to 8, from 0.5 to 7, from 0.5 to 6, from 0.5 to 5, from 0.5 to 4.5, from 0.5 to 4, from 0.5 to 3.5, from 0.5 to 3, from 0.5 to 2.5, from 0.5 to 2, from 0.5 to 1.9, from 0.5 to 1.8, from 0.5 to 1.7, from 0.5 to 1.6, from 0.5 to 1.5, from 0.5 to 1.4, from 0.5 to 1.3, from 0.5 to 1.2, from 0.5 to 1.1, from 0.5 to 1, from 0.5 to 0.9, from 0.5 to 0.8, from 0.5 to 0.7, from 0.5 to 0.6, from 0.6 to 15, from 0.6 to 14, from 0.6 to 13, from 0.6 to 12, from 0.6 to 11, from 0.6 to 10, from 0.6 to 9, from 0.6 to 8, from 0.6 to 7, from 0.6 to 6, from 0.6 to 5, from 0.6 to 4.5, from 0.6 to 4, from 0.6 to 3.5, from 0.6 to 3, from 0.6 to 2.5, from 0.6 to 2, from 0.6 to 1.9, from 0.6 to 1.8, from 0.6 to 1.7, from 0.6 to 1.6, from 0.6 to 1.5, from 0.6 to 1.4, from 0.6 to 1.3, from 0.6 to 1.2, from 0.6 to 1.1, from 0.6 to 1, from 0.6 to 0.9, from 0.6 to 0.8, from 0.6 to 0.7, from 0.7 to 15, from 0.7 to 14, from 0.7 to 13, from 0.7 to 12, from 0.7 to 11, from 0.7 to 10, from 0.7 to 9, from 0.7 to 8, from 0.7 to 7, from 0.7 to 6, from 0.7 to 5, from 0.7 to 4.5, from 0.7 to 4, from 0.7 to 3.5, from 0.7 to 3, from 0.7 to 2.5, from 0.7 to 2, from 0.7 to 1.9, from 0.7 to 1.8, from 0.7 to 1.7, from 0.7 to 1.6, from 0.7 to 1.5, from 0.7 to 1.4, from 0.7 to 1.3, from 0.7 to 1.2, from 0.7 to 1.1, from 0.7 to 1, from 0.7 to 0.9, from 0.7 to 0.8, from 0.8 to 15, from 0.8 to 14, from 0.8 to 13, from 0.8 to 12, from 0.8 to 11, from 0.8 to 10, from 0.8 to 9, from 0.8 to 8, from 0.8 to 7, from 0.8 to 6, from 0.8 to 5, from 0.8 to 4.5, from 0.8 to 4, from 0.8 to 3.5, from 0.8 to 3, from 0.8 to 2.5, from 0.8 to 2, from 0.8 to 1.9, from 0.8 to 1.8, from 0.8 to 1.7, from 0.8 to 1.6, from 0.8 to 1.5, from 0.8 to 1.4, from 0.8 to 1.3, from 0.8 to 1.2, from 0.8 to 1.1, from 0.8 to 1, from 0.8 to 0.9, from 0.9 to 15, from 0.9 to 14, from 0.9 to 13, from 0.9 to 12, from 0.9 to 11, from 0.9 to 10, from 0.9 to 9, from 0.9 to 8, from 0.9 to 7, from 0.9 to 6, from 0.9 to 5, from 0.9 to 4.5, from 0.9 to 4, from 0.9 to 3.5, from 0.9 to 3, from 0.9 to 2.5, from 0.9 to 2, from 0.9 to 1.9, from 0.9 to 1.8, from 0.9 to 1.7, from 0.9 to 1.6, from 0.9 to 1.5, from 0.9 to 1.4, from 0.9 to 1.3, from 0.9 to 1.2, from 0.9 to 1.1, from 0.9 to 1, from 1 to 15, from 1 to 14, from 1 to 13, from 1 to 12, from 1 to 11, from 1 to 10, from 1 to 9, from 1 to 8, from 1 to 7, from 1 to 6, from 1 to 5, from 1 to 4.5, from 1 to 4, from 1 to 3.5, from 1 to 3, from 1 to 2.5, from 1 to 2, from 1 to 1.9, from 1 to 1.8, from 1 to 1.7, from 1 to 1.6, from 1 to 1.5, from 1 to 1.4, from 1 to 1.3, from 1 to 1.2, from 1 to 1.1, from 1.1 to 15, from 1.1 to 14, from 1.1 to 13, from 1.1 to 12, from 1.1 to 11, from 1.1 to 10, from 1.1 to 9, from 1.1 to 8, from 1.1 to 7, from 1.1 to 6, from 1.1 to 5, from 1.1 to 4.5, from 1.1 to 4, from 1.1 to 3.5, from 1.1 to 3, from 1.1 to 2.5, from 1.1 to 2, from 1.1 to 1.9, from 1.1 to 1.8, from 1.1 to 1.7, from 1.1 to 1.6, from 1.1 to 1.5, from 1.1 to 1.4, from 1.1 to 1.3, from 1.1 to 1.2, from 1.2 to 15, from 1.2 to 14, from 1.2 to 13, from 1.2 to 12, from 1.2 to 11, from 1.2 to 10, from 1.2 to 9, from 1.2 to 8, from 1.2 to 7, from 1.2 to 6, from 1.2 to 5, from 1.2 to 4.5, from 1.2 to 4, from 1.2 to 3.5, from 1.2 to 3, from 1.2 to 2.5, from 1.2 to 2, from 1.2 to 1.9, from 1.2 to 1.8, from 1.2 to 1.7, from 1.2 to 1.6, from 1.2 to 1.5, from 1.2 to 1.4, from 1.2 to 1.3, from 1.3 to 15, from 1.3 to 14, from 1.3 to 13, from 1.3 to 12, from 1.3 to 11, from 1.3 to 10, from 1.3 to 9, from 1.3 to 8, from 1.3 to 7, from 1.3 to 6, from 1.3 to 5, from 1.3 to 4.5, from 1.3 to 4, from 1.3 to 3.5, from 1.3 to 3, from 1.3 to 2.5, from 1.3 to 2, from 1.3 to 1.9, from 1.3 to 1.8, from 1.3 to 1.7, from 1.3 to 1.6, from 1.3 to 1.5, from 1.3 to 1.4, from 1.4 to 15, from 1.4 to 14, from 1.4 to 13, from 1.4 to 12, from 1.4 to 11, from 1.4 to 10, from 1.4 to 9, from 1.4 to 8, from 1.4 to 7, from 1.4 to 6, from 1.4 to 5, from 1.4 to 4.5, from 1.4 to 4, from 1.4 to 3.5, from 1.4 to 3, from 1.4 to 2.5, from 1.4 to 2, from 1.4 to 1.9, from 1.4 to 1.8, from 1.4 to 1.7, from 1.4 to 1.6, from 1.4 to 1.5, from 1.5 to 15, from 1.5 to 14, from 1.5 to 13, from 1.5 to 12, from 1.5 to 11, from 1.5 to 10, from 1.5 to 9, from 1.5 to 8, from 1.5 to 7, from 1.5 to 6, from 1.5 to 5, from 1.5 to 4.5, from 1.5 to 4, from 1.5 to 3.5, from 1.5 to 3, from 1.5 to 2.5, from 1.5 to 2, from 1.5 to 1.9, from 1.5 to 1.8, from 1.5 to 1.7, from 1.5 to 1.6, from 1.6 to 15, from 1.6 to 14, from 1.6 to 13, from 1.6 to 12, from 1.6 to 11, from 1.6 to 10, from 1.6 to 9, from 1.6 to 8, from 1.6 to 7, from 1.6 to 6, from 1.6 to 5, from 1.6 to 4.5, from 1.6 to 4, from 1.6 to 3.5, from 1.6 to 3, from 1.6 to 2.5, from 1.6 to 2, from 1.6 to 1.9, from 1.6 to 1.8, from 1.6 to 1.7, from 1.7 to 15, from 1.7 to 14, from 1.7 to 13, from 1.7 to 12, from 1.7 to 11, from 1.7 to 10, from 1.7 to 9, from 1.7 to 8, from 1.7 to 7, from 1.7 to 6, from 1.7 to 5, from 1.7 to 4.5, from 1.7 to 4, from 1.7 to 3.5, from 1.7 to 3, from 1.7 to 2.5, from 1.7 to 2, from 1.7 to 1.9, from 1.7 to 1.8, from 1.8 to 15, from 1.8 to 14, from 1.8 to 13, from 1.8 to 12, from 1.8 to 11, from 1.8 to 10, from 1.8 to 9, from 1.8 to 8, from 1.8 to 7, from 1.8 to 6, from 1.8 to 5, from 1.8 to 4.5, from 1.8 to 4, from 1.8 to 3.5, from 1.8 to 3, from 1.8 to 2.5, from 1.8 to 2, from 1.8 to 1.9, from 1.9 to 15, from 1.9 to 14, from 1.9 to 13, from 1.9 to 12, from 1.9 to 11, from 1.9 to 10, from 1.9 to 9, from 1.9 to 8, from 1.9 to 7, from 1.9 to 6, from 1.9 to 5, from 1.9 to 4.5, from 1.9 to 4, from 1.9 to 3.5, from 1.9 to 3, from 1.9 to 2.5, from 1.9 to 2, from 2 to 15, from 2 to 14, from 2 to 13, from 2 to 12, from 2 to 11, from 2 to 10, from 2 to 9, from 2 to 8, from 2 to 7, from 2 to 6, from 2 to 5, from 2 to 4.5, from 2 to 4, from 2 to 3.5, from 2 to 3, from 2 to 2.5, from 2.5 to 15, from 2.5 to 14, from 2.5 to 13, from 2.5 to 12, from 2.5 to 11, from 2.5 to 10, from 2.5 to 9, from 2.5 to 8, from 2.5 to 7, from 2.5 to 6, from 2.5 to 5, from 2.5 to 4.5, from 2.5 to 4, from 2.5 to 3.5, from 2.5 to 3, from 3 to 15, from 3 to 14, from 3 to 13, from 3 to 12, from 3 to 11, from 3 to 10, from 3 to 9, from 3 to 8, from 3 to 7, from 3 to 6, from 3 to 5, from 3 to 4.5, from 3 to 4, from 3 to 3.5, from 3.5 to 15, from 3.5 to 14, from 3.5 to 13, from 3.5 to 12, from 3.5 to 11, from 3.5 to 10, from 3.5 to 9, from 3.5 to 8, from 3.5 to 7, from 3.5 to 6, from 3.5 to 5, from 3.5 to 4.5, from 3.5 to 4, from 4 to 15, from 4 to 14, from 4 to 13, from 4 to 12, from 4 to 11, from 4 to 10, from 4 to 9, from 4 to 8, from 4 to 7, from 4 to 6, from 4 to 5, from 4 to 4.5, from 4.5 to 15, from 4.5 to 14, from 4.5 to 13, from 4.5 to 12, from 4.5 to 11, from 4.5 to 10, from 4.5 to 9, from 4.5 to 8, from 4.5 to 7, from 4.5 to 6, from 4.5 to 5, from 5 to 15, from 5 to 14, from 5 to 13, from 5 to 12, from 5 to 11, from 5 to 10, from 5 to 9, from 5 to 8, from 5 to 7, from 5 to 6, from 6 to 15, from 6 to 14, from 6 to 13, from 6 to 12, from 6 to 11, from 6 to 10, from 6 to 9, from 6 to 8, from 6 to 7, from 7 to 15, from 7 to 14, from 7 to 13, from 7 to 12, from 7 to 11, from 7 to 10, from 7 to 9, from 7 to 8, from 8 to 15, from 8 to 14, from 8 to 13, from 8 to 12, from 8 to 11, from 8 to 10, from 8 to 9, from 9 to 15, from 9 to 14, from 9 to 13, from 9 to 12, from 9 to 11, from 9 to 10, from 10 to 15, from 10 to 14, from 10 to 13, from 10 to 12, from 10 to 11, from 11 to 15, from 11 to 14, from 11 to 13, from 11 to 12, from 12 to 15, from 12 to 14, from 12 to 13, from 13 to 15, from 13 to 14, or from 14 to 15) weight percent of a material comprising two or more polyisobutylene units linked by one or more acylating agent units.

In certain embodiments, the polyisobutylene comprises an average of 3 to 56 isobutylene monomeric units per molecule. In certain embodiments, the polyisobutylene comprises an average of 3 to 55 isobutylene monomeric units per molecule. In certain embodiments, the polyisobutylene comprises an average of 3 to 54 isobutylene monomeric units per molecule. In certain embodiments, the polyisobutylene comprises an average of 3 to 53 isobutylene monomeric units per molecule. In certain embodiments, the polyisobutylene comprises an average of 3 to 52 isobutylene monomeric units per molecule. In certain embodiments, the polyisobutylene comprises an average of 3 to 51 isobutylene monomeric units per molecule. In certain embodiments, the polyisobutylene comprises an average of 3 to 50 isobutylene monomeric units per molecule. In certain embodiments, the polyisobutylene comprises an average of 3 to 48 isobutylene monomeric units per molecule. In certain embodiments, the polyisobutylene comprises an average of 3 to 46 isobutylene monomeric units per molecule. In certain embodiments, the polyisobutylene comprises an average of 3 to 44 isobutylene monomeric units per molecule. In certain embodiments, the polyisobutylene comprises an average of 3 to 42 isobutylene monomeric units per molecule. In certain embodiments, the polyisobutylene comprises an average of 3 to 40 isobutylene monomeric units per molecule. In certain embodiments, the polyisobutylene comprises an average of 3 to 38 isobutylene monomeric units per molecule. In certain embodiments, the polyisobutylene comprises an average of 3 to 36 isobutylene monomeric units per molecule. In certain embodiments, the polyisobutylene comprises an average of 3 to 34 isobutylene monomeric units per molecule. In certain embodiments, the polyisobutylene comprises an average of 3 to 32 isobutylene monomeric units per molecule. In certain embodiments, the polyisobutylene comprises an average of 3 to 30 isobutylene monomeric units per molecule. In certain embodiments, the polyisobutylene comprises an average of 3 to 28 isobutylene monomeric units per molecule. In certain embodiments, the polyisobutylene comprises an average of 3 to 26 isobutylene monomeric units per molecule. In certain embodiments, the polyisobutylene comprises an average of 3 to 24 isobutylene monomeric units per molecule. In certain embodiments, the polyisobutylene comprises an average of 3 to 22 isobutylene monomeric units per molecule. In certain embodiments, the polyisobutylene comprises an average of 3 to 20 isobutylene monomeric units per molecule. In certain embodiments, the polyisobutylene comprises an average of 3 to 18 isobutylene monomeric units per molecule. In certain embodiments, the polyisobutylene comprises an average of 3 to 16 isobutylene monomeric units per molecule. In certain embodiments, the polyisobutylene comprises an average of 3 to 14 isobutylene monomeric units per molecule. In certain embodiments, the polyisobutylene comprises an average of 3 to 12 isobutylene monomeric units per molecule. In certain embodiments, the polyisobutylene comprises an average of 3 to 10 isobutylene monomeric units per molecule. In certain embodiments, the polyisobutylene comprises an average of 3 to 9 isobutylene monomeric units per molecule. In certain embodiments, the polyisobutylene comprises an average of 3 to 8 isobutylene monomeric units per molecule. In certain embodiments, the polyisobutylene comprises an average of 3 to 7 isobutylene monomeric units per molecule. In certain embodiments, the polyisobutylene comprises an average of 3 to 6 isobutylene monomeric units per molecule. In certain embodiments, the polyisobutylene comprises an average of 3 to 5 isobutylene monomeric units per molecule. In certain embodiments, the polyisobutylene comprises an average of 3 to 4 isobutylene monomeric units per molecule. In certain embodiments, the polyisobutylene comprises an average of 4 to 56 isobutylene monomeric units per molecule. In certain embodiments, the polyisobutylene comprises an average of 4 to 55 isobutylene monomeric units per molecule. In certain embodiments, the polyisobutylene comprises an average of 4 to 54 isobutylene monomeric units per molecule. In certain embodiments, the polyisobutylene comprises an average of 4 to 53 isobutylene monomeric units per molecule. In certain embodiments, the polyisobutylene comprises an average of 4 to 52 isobutylene monomeric units per molecule. In certain embodiments, the polyisobutylene comprises an average of 4 to 51 isobutylene monomeric units per molecule. In certain embodiments, the polyisobutylene comprises an average of 4 to 50 isobutylene monomeric units per molecule. In certain embodiments, the polyisobutylene comprises an average of 4 to 48 isobutylene monomeric units per molecule. In certain embodiments, the polyisobutylene comprises an average of 4 to 46 isobutylene monomeric units per molecule. In certain embodiments, the polyisobutylene comprises an average of 4 to 44 isobutylene monomeric units per molecule. In certain embodiments, the polyisobutylene comprises an average of 4 to 42 isobutylene monomeric units per molecule. In certain embodiments, the polyisobutylene comprises an average of 4 to 40 isobutylene monomeric units per molecule. In certain embodiments, the polyisobutylene comprises an average of 4 to 38 isobutylene monomeric units per molecule. In certain embodiments, the polyisobutylene comprises an average of 4 to 36 isobutylene monomeric units per molecule. In certain embodiments, the polyisobutylene comprises an average of 4 to 34 isobutylene monomeric units per molecule. In certain embodiments, the polyisobutylene comprises an average of 4 to 32 isobutylene monomeric units per molecule. In certain embodiments, the polyisobutylene comprises an average of 4 to 30 isobutylene monomeric units per molecule. In certain embodiments, the polyisobutylene comprises an average of 4 to 28 isobutylene monomeric units per molecule. In certain embodiments, the polyisobutylene comprises an average of 4 to 26 isobutylene monomeric units per molecule. In certain embodiments, the polyisobutylene comprises an average of 4 to 24 isobutylene monomeric units per molecule. In certain embodiments, the polyisobutylene comprises an average of 4 to 22 isobutylene monomeric units per molecule. In certain embodiments, the polyisobutylene comprises an average of 4 to 20 isobutylene monomeric units per molecule. In certain embodiments, the polyisobutylene comprises an average of 4 to 18 isobutylene monomeric units per molecule. In certain embodiments, the polyisobutylene comprises an average of 4 to 16 isobutylene monomeric units per molecule. In certain embodiments, the polyisobutylene comprises an average of 4 to 14 isobutylene monomeric units per molecule. In certain embodiments, the polyisobutylene comprises an average of 4 to 12 isobutylene monomeric units per molecule. In certain embodiments, the polyisobutylene comprises an average of 4 to 10 isobutylene monomeric units per molecule. In certain embodiments, the polyisobutylene comprises an average of 4 to 9 isobutylene monomeric units per molecule. In certain embodiments, the polyisobutylene comprises an average of 4 to 8 isobutylene monomeric units per molecule. In certain embodiments, the polyisobutylene comprises an average of 4 to 7 isobutylene monomeric units per molecule. In certain embodiments, the polyisobutylene comprises an average of 4 to 6 isobutylene monomeric units per molecule. In certain embodiments, the polyisobutylene comprises an average of 4 to 5 isobutylene monomeric units per molecule. In certain embodiments, the polyisobutylene comprises an average of 5 to 56 isobutylene monomeric units per molecule. In certain embodiments, the polyisobutylene comprises an average of 5 to 55 isobutylene monomeric units per molecule. In certain embodiments, the polyisobutylene comprises an average of 5 to 54 isobutylene monomeric units per molecule. In certain embodiments, the polyisobutylene comprises an average of 5 to 53 isobutylene monomeric units per molecule. In certain embodiments, the polyisobutylene comprises an average of 5 to 52 isobutylene monomeric units per molecule. In certain embodiments, the polyisobutylene comprises an average of 5 to 51 isobutylene monomeric units per molecule. In certain embodiments, the polyisobutylene comprises an average of 5 to 50 isobutylene monomeric units per molecule. In certain embodiments, the polyisobutylene comprises an average of 5 to 48 isobutylene monomeric units per molecule. In certain embodiments, the polyisobutylene comprises an average of 5 to 46 isobutylene monomeric units per molecule. In certain embodiments, the polyisobutylene comprises an average of 5 to 44 isobutylene monomeric units per molecule. In certain embodiments, the polyisobutylene comprises an average of 5 to 42 isobutylene monomeric units per molecule. In certain embodiments, the polyisobutylene comprises an average of 5 to 40 isobutylene monomeric units per molecule. In certain embodiments, the polyisobutylene comprises an average of 5 to 38 isobutylene monomeric units per molecule. In certain embodiments, the polyisobutylene comprises an average of 5 to 36 isobutylene monomeric units per molecule. In certain embodiments, the polyisobutylene comprises an average of 5 to 34 isobutylene monomeric units per molecule. In certain embodiments, the polyisobutylene comprises an average of 5 to 32 isobutylene monomeric units per molecule. In certain embodiments, the polyisobutylene comprises an average of 5 to 30 isobutylene monomeric units per molecule. In certain embodiments, the polyisobutylene comprises an average of 5 to 28 isobutylene monomeric units per molecule. In certain embodiments, the polyisobutylene comprises an average of 5 to 26 isobutylene monomeric units per molecule. In certain embodiments, the polyisobutylene comprises an average of 5 to 24 isobutylene monomeric units per molecule. In certain embodiments, the polyisobutylene comprises an average of 5 to 22 isobutylene monomeric units per molecule. In certain embodiments, the polyisobutylene comprises an average of 5 to 20 isobutylene monomeric units per molecule. In certain embodiments, the polyisobutylene comprises an average of 5 to 18 isobutylene monomeric units per molecule. In certain embodiments, the polyisobutylene comprises an average of 5 to 16 isobutylene monomeric units per molecule. In certain embodiments, the polyisobutylene comprises an average of 5 to 14 isobutylene monomeric units per molecule. In certain embodiments, the polyisobutylene comprises an average of 5 to 12 isobutylene monomeric units per molecule. In certain embodiments, the polyisobutylene comprises an average of 5 to 10 isobutylene monomeric units per molecule. In certain embodiments, the polyisobutylene comprises an average of 5 to 9 isobutylene monomeric units per molecule. In certain embodiments, the polyisobutylene comprises an average of 5 to 8 isobutylene monomeric units per molecule. In certain embodiments, the polyisobutylene comprises an average of 5 to 7 isobutylene monomeric units per molecule. In certain embodiments, the polyisobutylene comprises an average of 5 to 6 isobutylene monomeric units per molecule. In certain embodiments, the polyisobutylene comprises an average of 6 to 56 isobutylene monomeric units per molecule. In certain embodiments, the polyisobutylene comprises an average of 6 to 55 isobutylene monomeric units per molecule. In certain embodiments, the polyisobutylene comprises an average of 6 to 54 isobutylene monomeric units per molecule. In certain embodiments, the polyisobutylene comprises an average of 6 to 53 isobutylene monomeric units per molecule. In certain embodiments, the polyisobutylene comprises an average of 6 to 52 isobutylene monomeric units per molecule. In certain embodiments, the polyisobutylene comprises an average of 6 to 51 isobutylene monomeric units per molecule. In certain embodiments, the polyisobutylene comprises an average of 6 to 50 isobutylene monomeric units per molecule. In certain embodiments, the polyisobutylene comprises an average of 6 to 48 isobutylene monomeric units per molecule. In certain embodiments, the polyisobutylene comprises an average of 6 to 46 isobutylene monomeric units per molecule. In certain embodiments, the polyisobutylene comprises an average of 6 to 44 isobutylene monomeric units per molecule. In certain embodiments, the polyisobutylene comprises an average of 6 to 42 isobutylene monomeric units per molecule. In certain embodiments, the polyisobutylene comprises an average of 6 to 40 isobutylene monomeric units per molecule. In certain embodiments, the polyisobutylene comprises an average of 6 to 38 isobutylene monomeric units per molecule. In certain embodiments, the polyisobutylene comprises an average of 6 to 36 isobutylene monomeric units per molecule. In certain embodiments, the polyisobutylene comprises an average of 6 to 34 isobutylene monomeric units per molecule. In certain embodiments, the polyisobutylene comprises an average of 6 to 32 isobutylene monomeric units per molecule. In certain embodiments, the polyisobutylene comprises an average of 6 to 30 isobutylene monomeric units per molecule. In certain embodiments, the polyisobutylene comprises an average of 6 to 28 isobutylene monomeric units per molecule. In certain embodiments, the polyisobutylene comprises an average of 6 to 26 isobutylene monomeric units per molecule. In certain embodiments, the polyisobutylene comprises an average of 6 to 24 isobutylene monomeric units per molecule. In certain embodiments, the polyisobutylene comprises an average of 6 to 22 isobutylene monomeric units per molecule. In certain embodiments, the polyisobutylene comprises an average of 6 to 20 isobutylene monomeric units per molecule. In certain embodiments, the polyisobutylene comprises an average of 6 to 18 isobutylene monomeric units per molecule. In certain embodiments, the polyisobutylene comprises an average of 6 to 16 isobutylene monomeric units per molecule. In certain embodiments, the polyisobutylene comprises an average of 6 to 14 isobutylene monomeric units per molecule. In certain embodiments, the polyisobutylene comprises an average of 6 to 12 isobutylene monomeric units per molecule. In certain embodiments, the polyisobutylene comprises an average of 6 to 10 isobutylene monomeric units per molecule. In certain embodiments, the polyisobutylene comprises an average of 6 to 9 isobutylene monomeric units per molecule. In certain embodiments, the polyisobutylene comprises an average of 6 to 8 isobutylene monomeric units per molecule. In certain embodiments, the polyisobutylene comprises an average of 6 to 7 isobutylene monomeric units per molecule. In certain embodiments, the polyisobutylene comprises an average of 7 to 56 isobutylene monomeric units per molecule. In certain embodiments, the polyisobutylene comprises an average of 7 to 55 isobutylene monomeric units per molecule. In certain embodiments, the polyisobutylene comprises an average of 7 to 54 isobutylene monomeric units per molecule. In certain embodiments, the polyisobutylene comprises an average of 7 to 53 isobutylene monomeric units per molecule. In certain embodiments, the polyisobutylene comprises an average of 7 to 52 isobutylene monomeric units per molecule. In certain embodiments, the polyisobutylene comprises an average of 7 to 51 isobutylene monomeric units per molecule. In certain embodiments, the polyisobutylene comprises an average of 7 to 50 isobutylene monomeric units per molecule. In certain embodiments, the polyisobutylene comprises an average of 7 to 48 isobutylene monomeric units per molecule. In certain embodiments, the polyisobutylene comprises an average of 7 to 46 isobutylene monomeric units per molecule. In certain embodiments, the polyisobutylene comprises an average of 7 to 44 isobutylene monomeric units per molecule. In certain embodiments, the polyisobutylene comprises an average of 7 to 42 isobutylene monomeric units per molecule. In certain embodiments, the polyisobutylene comprises an average of 7 to 40 isobutylene monomeric units per molecule. In certain embodiments, the polyisobutylene comprises an average of 7 to 38 isobutylene monomeric units per molecule. In certain embodiments, the polyisobutylene comprises an average of 7 to 36 isobutylene monomeric units per molecule. In certain embodiments, the polyisobutylene comprises an average of 7 to 34 isobutylene monomeric units per molecule. In certain embodiments, the polyisobutylene comprises an average of 7 to 32 isobutylene monomeric units per molecule. In certain embodiments, the polyisobutylene comprises an average of 7 to 30 isobutylene monomeric units per molecule. In certain embodiments, the polyisobutylene comprises an average of 7 to 28 isobutylene monomeric units per molecule. In certain embodiments, the polyisobutylene comprises an average of 7 to 26 isobutylene monomeric units per molecule. In certain embodiments, the polyisobutylene comprises an average of 7 to 24 isobutylene monomeric units per molecule. In certain embodiments, the polyisobutylene comprises an average of 7 to 22 isobutylene monomeric units per molecule. In certain embodiments, the polyisobutylene comprises an average of 7 to 20 isobutylene monomeric units per molecule. In certain embodiments, the polyisobutylene comprises an average of 7 to 18 isobutylene monomeric units per molecule. In certain embodiments, the polyisobutylene comprises an average of 7 to 16 isobutylene monomeric units per molecule. In certain embodiments, the polyisobutylene comprises an average of 7 to 14 isobutylene monomeric units per molecule. In certain embodiments, the polyisobutylene comprises an average of 7 to 12 isobutylene monomeric units per molecule. In certain embodiments, the polyisobutylene comprises an average of 7 to 10 isobutylene monomeric units per molecule. In certain embodiments, the polyisobutylene comprises an average of 7 to 9 isobutylene monomeric units per molecule. In certain embodiments, the polyisobutylene comprises an average of 7 to 8 isobutylene monomeric units per molecule. In certain embodiments, the polyisobutylene comprises an average of 8 to 56 isobutylene monomeric units per molecule. In certain embodiments, the polyisobutylene comprises an average of 8 to 55 isobutylene monomeric units per molecule. In certain embodiments, the polyisobutylene comprises an average of 8 to 54 isobutylene monomeric units per molecule. In certain embodiments, the polyisobutylene comprises an average of 8 to 53 isobutylene monomeric units per molecule. In certain embodiments, the polyisobutylene comprises an average of 8 to 52 isobutylene monomeric units per molecule. In certain embodiments, the polyisobutylene comprises an average of 8 to 51 isobutylene monomeric units per molecule. In certain embodiments, the polyisobutylene comprises an average of 8 to 50 isobutylene monomeric units per molecule. In certain embodiments, the polyisobutylene comprises an average of 8 to 48 isobutylene monomeric units per molecule. In certain embodiments, the polyisobutylene comprises an average of 8 to 46 isobutylene monomeric units per molecule. In certain embodiments, the polyisobutylene comprises an average of 8 to 44 isobutylene monomeric units per molecule. In certain embodiments, the polyisobutylene comprises an average of 8 to 42 isobutylene monomeric units per molecule. In certain embodiments, the polyisobutylene comprises an average of 8 to 40 isobutylene monomeric units per molecule. In certain embodiments, the polyisobutylene comprises an average of 8 to 38 isobutylene monomeric units per molecule. In certain embodiments, the polyisobutylene comprises an average of 8 to 36 isobutylene monomeric units per molecule. In certain embodiments, the polyisobutylene comprises an average of 8 to 34 isobutylene monomeric units per molecule. In certain embodiments, the polyisobutylene comprises an average of 8 to 32 isobutylene monomeric units per molecule. In certain embodiments, the polyisobutylene comprises an average of 8 to 30 isobutylene monomeric units per molecule. In certain embodiments, the polyisobutylene comprises an average of 8 to 28 isobutylene monomeric units per molecule. In certain embodiments, the polyisobutylene comprises an average of 8 to 26 isobutylene monomeric units per molecule. In certain embodiments, the polyisobutylene comprises an average of 8 to 24 isobutylene monomeric units per molecule. In certain embodiments, the polyisobutylene comprises an average of 8 to 22 isobutylene monomeric units per molecule. In certain embodiments, the polyisobutylene comprises an average of 8 to 20 isobutylene monomeric units per molecule. In certain embodiments, the polyisobutylene comprises an average of 8 to 18 isobutylene monomeric units per molecule. In certain embodiments, the polyisobutylene comprises an average of 8 to 16 isobutylene monomeric units per molecule. In certain embodiments, the polyisobutylene comprises an average of 8 to 14 isobutylene monomeric units per molecule. In certain embodiments, the polyisobutylene comprises an average of 8 to 12 isobutylene monomeric units per molecule. In certain embodiments, the polyisobutylene comprises an average of 8 to 10 isobutylene monomeric units per molecule. In certain embodiments, the polyisobutylene comprises an average of 8 to 9 isobutylene monomeric units per molecule. In certain embodiments, the polyisobutylene comprises an average of 9 to 56 isobutylene monomeric units per molecule. In certain embodiments, the polyisobutylene comprises an average of 9 to 55 isobutylene monomeric units per molecule. In certain embodiments, the polyisobutylene comprises an average of 9 to 54 isobutylene monomeric units per molecule. In certain embodiments, the polyisobutylene comprises an average of 9 to 53 isobutylene monomeric units per molecule. In certain embodiments, the polyisobutylene comprises an average of 9 to 52 isobutylene monomeric units per molecule. In certain embodiments, the polyisobutylene comprises an average of 9 to 51 isobutylene monomeric units per molecule. In certain embodiments, the polyisobutylene comprises an average of 9 to 50 isobutylene monomeric units per molecule. In certain embodiments, the polyisobutylene comprises an average of 9 to 48 isobutylene monomeric units per molecule. In certain embodiments, the polyisobutylene comprises an average of 9 to 46 isobutylene monomeric units per molecule. In certain embodiments, the polyisobutylene comprises an average of 9 to 44 isobutylene monomeric units per molecule. In certain embodiments, the polyisobutylene comprises an average of 9 to 42 isobutylene monomeric units per molecule. In certain embodiments, the polyisobutylene comprises an average of 9 to 40 isobutylene monomeric units per molecule. In certain embodiments, the polyisobutylene comprises an average of 9 to 38 isobutylene monomeric units per molecule. In certain embodiments, the polyisobutylene comprises an average of 9 to 36 isobutylene monomeric units per molecule. In certain embodiments, the polyisobutylene comprises an average of 9 to 34 isobutylene monomeric units per molecule. In certain embodiments, the polyisobutylene comprises an average of 9 to 32 isobutylene monomeric units per molecule. In certain embodiments, the polyisobutylene comprises an average of 9 to 30 isobutylene monomeric units per molecule. In certain embodiments, the polyisobutylene comprises an average of 9 to 28 isobutylene monomeric units per molecule. In certain embodiments, the polyisobutylene comprises an average of 9 to 26 isobutylene monomeric units per molecule. In certain embodiments, the polyisobutylene comprises an average of 9 to 24 isobutylene monomeric units per molecule. In certain embodiments, the polyisobutylene comprises an average of 9 to 22 isobutylene monomeric units per molecule. In certain embodiments, the polyisobutylene comprises an average of 9 to 20 isobutylene monomeric units per molecule. In certain embodiments, the polyisobutylene comprises an average of 9 to 18 isobutylene monomeric units per molecule. In certain embodiments, the polyisobutylene comprises an average of 9 to 16 isobutylene monomeric units per molecule. In certain embodiments, the polyisobutylene comprises an average of 9 to 14 isobutylene monomeric units per molecule. In certain embodiments, the polyisobutylene comprises an average of 9 to 12 isobutylene monomeric units per molecule. In certain embodiments, the polyisobutylene comprises an average of 9 to 10 isobutylene monomeric units per molecule. In certain embodiments, the polyisobutylene comprises an average of 10 to 56 isobutylene monomeric units per molecule. In certain embodiments, the polyisobutylene comprises an average of 10 to 55 isobutylene monomeric units per molecule. In certain embodiments, the polyisobutylene comprises an average of 10 to 54 isobutylene monomeric units per molecule. In certain embodiments, the polyisobutylene comprises an average of 10 to 53 isobutylene monomeric units per molecule. In certain embodiments, the polyisobutylene comprises an average of 10 to 52 isobutylene monomeric units per molecule. In certain embodiments, the polyisobutylene comprises an average of 10 to 51 isobutylene monomeric units per molecule. In certain embodiments, the polyisobutylene comprises an average of 10 to 50 isobutylene monomeric units per molecule. In certain embodiments, the polyisobutylene comprises an average of 10 to 48 isobutylene monomeric units per molecule. In certain embodiments, the polyisobutylene comprises an average of 10 to 46 isobutylene monomeric units per molecule. In certain embodiments, the polyisobutylene comprises an average of 10 to 44 isobutylene monomeric units per molecule. In certain embodiments, the polyisobutylene comprises an average of 10 to 42 isobutylene monomeric units per molecule. In certain embodiments, the polyisobutylene comprises an average of 10 to 40 isobutylene monomeric units per molecule. In certain embodiments, the polyisobutylene comprises an average of 10 to 38 isobutylene monomeric units per molecule. In certain embodiments, the polyisobutylene comprises an average of 10 to 36 isobutylene monomeric units per molecule. In certain embodiments, the polyisobutylene comprises an average of 10 to 34 isobutylene monomeric units per molecule. In certain embodiments, the polyisobutylene comprises an average of 10 to 32 isobutylene monomeric units per molecule. In certain embodiments, the polyisobutylene comprises an average of 10 to 30 isobutylene monomeric units per molecule. In certain embodiments, the polyisobutylene comprises an average of 10 to 28 isobutylene monomeric units per molecule. In certain embodiments, the polyisobutylene comprises an average of 10 to 26 isobutylene monomeric units per molecule. In certain embodiments, the polyisobutylene comprises an average of 10 to 24 isobutylene monomeric units per molecule. In certain embodiments, the polyisobutylene comprises an average of 10 to 22 isobutylene monomeric units per molecule. In certain embodiments, the polyisobutylene comprises an average of 10 to 20 isobutylene monomeric units per molecule. In certain embodiments, the polyisobutylene comprises an average of 10 to 18 isobutylene monomeric units per molecule. In certain embodiments, the polyisobutylene comprises an average of 10 to 16 isobutylene monomeric units per molecule. In certain embodiments, the polyisobutylene comprises an average of 10 to 14 isobutylene monomeric units per molecule. In certain embodiments, the polyisobutylene comprises an average of 10 to 12 isobutylene monomeric units per molecule. In certain embodiments, the polyisobutylene comprises an average of 12 to 56 isobutylene monomeric units per molecule. In certain embodiments, the polyisobutylene comprises an average of 12 to 55 isobutylene monomeric units per molecule. In certain embodiments, the polyisobutylene comprises an average of 12 to 54 isobutylene monomeric units per molecule. In certain embodiments, the polyisobutylene comprises an average of 12 to 53 isobutylene monomeric units per molecule. In certain embodiments, the polyisobutylene comprises an average of 12 to 52 isobutylene monomeric units per molecule. In certain embodiments, the polyisobutylene comprises an average of 12 to 51 isobutylene monomeric units per molecule. In certain embodiments, the polyisobutylene comprises an average of 12 to 50 isobutylene monomeric units per molecule. In certain embodiments, the polyisobutylene comprises an average of 12 to 48 isobutylene monomeric units per molecule. In certain embodiments, the polyisobutylene comprises an average of 12 to 46 isobutylene monomeric units per molecule. In certain embodiments, the polyisobutylene comprises an average of 12 to 44 isobutylene monomeric units per molecule. In certain embodiments, the polyisobutylene comprises an average of 12 to 42 isobutylene monomeric units per molecule. In certain embodiments, the polyisobutylene comprises an average of 12 to 40 isobutylene monomeric units per molecule. In certain embodiments, the polyisobutylene comprises an average of 12 to 38 isobutylene monomeric units per molecule. In certain embodiments, the polyisobutylene comprises an average of 12 to 36 isobutylene monomeric units per molecule. In certain embodiments, the polyisobutylene comprises an average of 12 to 34 isobutylene monomeric units per molecule. In certain embodiments, the polyisobutylene comprises an average of 12 to 32 isobutylene monomeric units per molecule. In certain embodiments, the polyisobutylene comprises an average of 12 to 30 isobutylene monomeric units per molecule. In certain embodiments, the polyisobutylene comprises an average of 12 to 28 isobutylene monomeric units per molecule. In certain embodiments, the polyisobutylene comprises an average of 12 to 26 isobutylene monomeric units per molecule. In certain embodiments, the polyisobutylene comprises an average of 12 to 24 isobutylene monomeric units per molecule. In certain embodiments, the polyisobutylene comprises an average of 12 to 22 isobutylene monomeric units per molecule. In certain embodiments, the polyisobutylene comprises an average of 12 to 20 isobutylene monomeric units per molecule. In certain embodiments, the polyisobutylene comprises an average of 12 to 18 isobutylene monomeric units per molecule. In certain embodiments, the polyisobutylene comprises an average of 12 to 16 isobutylene monomeric units per molecule. In certain embodiments, the polyisobutylene comprises an average of 12 to 14 isobutylene monomeric units per molecule. In certain embodiments, the polyisobutylene comprises an average of 14 to 56 isobutylene monomeric units per molecule. In certain embodiments, the polyisobutylene comprises an average of 14 to 55 isobutylene monomeric units per molecule. In certain embodiments, the polyisobutylene comprises an average of 14 to 54 isobutylene monomeric units per molecule. In certain embodiments, the polyisobutylene comprises an average of 14 to 53 isobutylene monomeric units per molecule. In certain embodiments, the polyisobutylene comprises an average of 14 to 52 isobutylene monomeric units per molecule. In certain embodiments, the polyisobutylene comprises an average of 14 to 51 isobutylene monomeric units per molecule. In certain embodiments, the polyisobutylene comprises an average of 14 to 50 isobutylene monomeric units per molecule. In certain embodiments, the polyisobutylene comprises an average of 14 to 48 isobutylene monomeric units per molecule. In certain embodiments, the polyisobutylene comprises an average of 14 to 46 isobutylene monomeric units per molecule. In certain embodiments, the polyisobutylene comprises an average of 14 to 44 isobutylene monomeric units per molecule. In certain embodiments, the polyisobutylene comprises an average of 14 to 42 isobutylene monomeric units per molecule. In certain embodiments, the polyisobutylene comprises an average of 14 to 40 isobutylene monomeric units per molecule. In certain embodiments, the polyisobutylene comprises an average of 14 to 38 isobutylene monomeric units per molecule. In certain embodiments, the polyisobutylene comprises an average of 14 to 36 isobutylene monomeric units per molecule. In certain embodiments, the polyisobutylene comprises an average of 14 to 34 isobutylene monomeric units per molecule. In certain embodiments, the polyisobutylene comprises an average of 14 to 32 isobutylene monomeric units per molecule. In certain embodiments, the polyisobutylene comprises an average of 14 to 30 isobutylene monomeric units per molecule. In certain embodiments, the polyisobutylene comprises an average of 14 to 28 isobutylene monomeric units per molecule. In certain embodiments, the polyisobutylene comprises an average of 14 to 26 isobutylene monomeric units per molecule. In certain embodiments, the polyisobutylene comprises an average of 14 to 24 isobutylene monomeric units per molecule. In certain embodiments, the polyisobutylene comprises an average of 14 to 22 isobutylene monomeric units per molecule. In certain embodiments, the polyisobutylene comprises an average of 14 to 20 isobutylene monomeric units per molecule. In certain embodiments, the polyisobutylene comprises an average of 14 to 18 isobutylene monomeric units per molecule. In certain embodiments, the polyisobutylene comprises an average of 14 to 16 isobutylene monomeric units per molecule. In certain embodiments, the polyisobutylene comprises an average of 16 to 56 isobutylene monomeric units per molecule. In certain embodiments, the polyisobutylene comprises an average of 16 to 55 isobutylene monomeric units per molecule. In certain embodiments, the polyisobutylene comprises an average of 16 to 54 isobutylene monomeric units per molecule. In certain embodiments, the polyisobutylene comprises an average of 16 to 53 isobutylene monomeric units per molecule. In certain embodiments, the polyisobutylene comprises an average of 16 to 52 isobutylene monomeric units per molecule. In certain embodiments, the polyisobutylene comprises an average of 16 to 51 isobutylene monomeric units per molecule. In certain embodiments, the polyisobutylene comprises an average of 16 to 50 isobutylene monomeric units per molecule. In certain embodiments, the polyisobutylene comprises an average of 16 to 48 isobutylene monomeric units per molecule. In certain embodiments, the polyisobutylene comprises an average of 16 to 46 isobutylene monomeric units per molecule. In certain embodiments, the polyisobutylene comprises an average of 16 to 44 isobutylene monomeric units per molecule. In certain embodiments, the polyisobutylene comprises an average of 16 to 42 isobutylene monomeric units per molecule. In certain embodiments, the polyisobutylene comprises an average of 16 to 40 isobutylene monomeric units per molecule. In certain embodiments, the polyisobutylene comprises an average of 16 to 38 isobutylene monomeric units per molecule. In certain embodiments, the polyisobutylene comprises an average of 16 to 36 isobutylene monomeric units per molecule. In certain embodiments, the polyisobutylene comprises an average of 16 to 34 isobutylene monomeric units per molecule. In certain embodiments, the polyisobutylene comprises an average of 16 to 32 isobutylene monomeric units per molecule. In certain embodiments, the polyisobutylene comprises an average of 16 to 30 isobutylene monomeric units per molecule. In certain embodiments, the polyisobutylene comprises an average of 16 to 28 isobutylene monomeric units per molecule. In certain embodiments, the polyisobutylene comprises an average of 16 to 26 isobutylene monomeric units per molecule. In certain embodiments, the polyisobutylene comprises an average of 16 to 24 isobutylene monomeric units per molecule. In certain embodiments, the polyisobutylene comprises an average of 16 to 22 isobutylene monomeric units per molecule. In certain embodiments, the polyisobutylene comprises an average of 16 to 20 isobutylene monomeric units per molecule. In certain embodiments, the polyisobutylene comprises an average of 16 to 18 isobutylene monomeric units per molecule. In certain embodiments, the polyisobutylene comprises an average of 18 to 56 isobutylene monomeric units per molecule. In certain embodiments, the polyisobutylene comprises an average of 18 to 55 isobutylene monomeric units per molecule. In certain embodiments, the polyisobutylene comprises an average of 18 to 54 isobutylene monomeric units per molecule. In certain embodiments, the polyisobutylene comprises an average of 18 to 53 isobutylene monomeric units per molecule. In certain embodiments, the polyisobutylene comprises an average of 18 to 52 isobutylene monomeric units per molecule. In certain embodiments, the polyisobutylene comprises an average of 18 to 51 isobutylene monomeric units per molecule. In certain embodiments, the polyisobutylene comprises an average of 18 to 50 isobutylene monomeric units per molecule. In certain embodiments, the polyisobutylene comprises an average of 18 to 48 isobutylene monomeric units per molecule. In certain embodiments, the polyisobutylene comprises an average of 18 to 46 isobutylene monomeric units per molecule. In certain embodiments, the polyisobutylene comprises an average of 18 to 44 isobutylene monomeric units per molecule. In certain embodiments, the polyisobutylene comprises an average of 18 to 42 isobutylene monomeric units per molecule. In certain embodiments, the polyisobutylene comprises an average of 18 to 40 isobutylene monomeric units per molecule. In certain embodiments, the polyisobutylene comprises an average of 18 to 38 isobutylene monomeric units per molecule. In certain embodiments, the polyisobutylene comprises an average of 18 to 36 isobutylene monomeric units per molecule. In certain embodiments, the polyisobutylene comprises an average of 18 to 34 isobutylene monomeric units per molecule. In certain embodiments, the polyisobutylene comprises an average of 18 to 32 isobutylene monomeric units per molecule. In certain embodiments, the polyisobutylene comprises an average of 18 to 30 isobutylene monomeric units per molecule. In certain embodiments, the polyisobutylene comprises an average of 18 to 28 isobutylene monomeric units per molecule. In certain embodiments, the polyisobutylene comprises an average of 18 to 26 isobutylene monomeric units per molecule. In certain embodiments, the polyisobutylene comprises an average of 18 to 24 isobutylene monomeric units per molecule. In certain embodiments, the polyisobutylene comprises an average of 18 to 22 isobutylene monomeric units per molecule. In certain embodiments, the polyisobutylene comprises an average of 18 to 20 isobutylene monomeric units per molecule. In certain embodiments, the polyisobutylene comprises an average of 20 to 56 isobutylene monomeric units per molecule. In certain embodiments, the polyisobutylene comprises an average of 20 to 55 isobutylene monomeric units per molecule. In certain embodiments, the polyisobutylene comprises an average of 20 to 54 isobutylene monomeric units per molecule. In certain embodiments, the polyisobutylene comprises an average of 20 to 53 isobutylene monomeric units per molecule. In certain embodiments, the polyisobutylene comprises an average of 20 to 52 isobutylene monomeric units per molecule. In certain embodiments, the polyisobutylene comprises an average of 20 to 51 isobutylene monomeric units per molecule. In certain embodiments, the polyisobutylene comprises an average of 20 to 50 isobutylene monomeric units per molecule. In certain embodiments, the polyisobutylene comprises an average of 20 to 48 isobutylene monomeric units per molecule. In certain embodiments, the polyisobutylene comprises an average of 20 to 46 isobutylene monomeric units per molecule. In certain embodiments, the polyisobutylene comprises an average of 20 to 44 isobutylene monomeric units per molecule. In certain embodiments, the polyisobutylene comprises an average of 20 to 42 isobutylene monomeric units per molecule. In certain embodiments, the polyisobutylene comprises an average of 20 to 40 isobutylene monomeric units per molecule. In certain embodiments, the polyisobutylene comprises an average of 20 to 38 isobutylene monomeric units per molecule. In certain embodiments, the polyisobutylene comprises an average of 20 to 36 isobutylene monomeric units per molecule. In certain embodiments, the polyisobutylene comprises an average of 20 to 34 isobutylene monomeric units per molecule. In certain embodiments, the polyisobutylene comprises an average of 20 to 32 isobutylene monomeric units per molecule. In certain embodiments, the polyisobutylene comprises an average of 20 to 30 isobutylene monomeric units per molecule. In certain embodiments, the polyisobutylene comprises an average of 20 to 28 isobutylene monomeric units per molecule. In certain embodiments, the polyisobutylene comprises an average of 20 to 26 isobutylene monomeric units per molecule. In certain embodiments, the polyisobutylene comprises an average of 20 to 24 isobutylene monomeric units per molecule. In certain embodiments, the polyisobutylene comprises an average of 20 to 22 isobutylene monomeric units per molecule. In certain embodiments, the polyisobutylene comprises an average of 22 to 56 isobutylene monomeric units per molecule. In certain embodiments, the polyisobutylene comprises an average of 22 to 55 isobutylene monomeric units per molecule. In certain embodiments, the polyisobutylene comprises an average of 22 to 54 isobutylene monomeric units per molecule. In certain embodiments, the polyisobutylene comprises an average of 22 to 53 isobutylene monomeric units per molecule. In certain embodiments, the polyisobutylene comprises an average of 22 to 52 isobutylene monomeric units per molecule. In certain embodiments, the polyisobutylene comprises an average of 22 to 51 isobutylene monomeric units per molecule. In certain embodiments, the polyisobutylene comprises an average of 22 to 50 isobutylene monomeric units per molecule. In certain embodiments, the polyisobutylene comprises an average of 22 to 48 isobutylene monomeric units per molecule. In certain embodiments, the polyisobutylene comprises an average of 22 to 46 isobutylene monomeric units per molecule. In certain embodiments, the polyisobutylene comprises an average of 22 to 44 isobutylene monomeric units per molecule. In certain embodiments, the polyisobutylene comprises an average of 22 to 42 isobutylene monomeric units per molecule. In certain embodiments, the polyisobutylene comprises an average of 22 to 40 isobutylene monomeric units per molecule. In certain embodiments, the polyisobutylene comprises an average of 22 to 38 isobutylene monomeric units per molecule. In certain embodiments, the polyisobutylene comprises an average of 22 to 36 isobutylene monomeric units per molecule. In certain embodiments, the polyisobutylene comprises an average of 22 to 34 isobutylene monomeric units per molecule. In certain embodiments, the polyisobutylene comprises an average of 22 to 32 isobutylene monomeric units per molecule. In certain embodiments, the polyisobutylene comprises an average of 22 to 30 isobutylene monomeric units per molecule. In certain embodiments, the polyisobutylene comprises an average of 22 to 28 isobutylene monomeric units per molecule. In certain embodiments, the polyisobutylene comprises an average of 22 to 26 isobutylene monomeric units per molecule. In certain embodiments, the polyisobutylene comprises an average of 22 to 24 isobutylene monomeric units per molecule. In certain embodiments, the polyisobutylene comprises an average of 24 to 56 isobutylene monomeric units per molecule. In certain embodiments, the polyisobutylene comprises an average of 24 to 55 isobutylene monomeric units per molecule. In certain embodiments, the polyisobutylene comprises an average of 24 to 54 isobutylene monomeric units per molecule. In certain embodiments, the polyisobutylene comprises an average of 24 to 53 isobutylene monomeric units per molecule. In certain embodiments, the polyisobutylene comprises an average of 24 to 52 isobutylene monomeric units per molecule. In certain embodiments, the polyisobutylene comprises an average of 24 to 51 isobutylene monomeric units per molecule. In certain embodiments, the polyisobutylene comprises an average of 24 to 50 isobutylene monomeric units per molecule. In certain embodiments, the polyisobutylene comprises an average of 24 to 48 isobutylene monomeric units per molecule. In certain embodiments, the polyisobutylene comprises an average of 24 to 46 isobutylene monomeric units per molecule. In certain embodiments, the polyisobutylene comprises an average of 24 to 44 isobutylene monomeric units per molecule. In certain embodiments, the polyisobutylene comprises an average of 24 to 42 isobutylene monomeric units per molecule. In certain embodiments, the polyisobutylene comprises an average of 24 to 40 isobutylene monomeric units per molecule. In certain embodiments, the polyisobutylene comprises an average of 24 to 38 isobutylene monomeric units per molecule. In certain embodiments, the polyisobutylene comprises an average of 24 to 36 isobutylene monomeric units per molecule. In certain embodiments, the polyisobutylene comprises an average of 24 to 34 isobutylene monomeric units per molecule. In certain embodiments, the polyisobutylene comprises an average of 24 to 32 isobutylene monomeric units per molecule. In certain embodiments, the polyisobutylene comprises an average of 24 to 30 isobutylene monomeric units per molecule. In certain embodiments, the polyisobutylene comprises an average of 24 to 28 isobutylene monomeric units per molecule. In certain embodiments, the polyisobutylene comprises an average of 24 to 26 isobutylene monomeric units per molecule. In certain embodiments, the polyisobutylene comprises an average of 26 to 56 isobutylene monomeric units per molecule. In certain embodiments, the polyisobutylene comprises an average of 26 to 55 isobutylene monomeric units per molecule. In certain embodiments, the polyisobutylene comprises an average of 26 to 54 isobutylene monomeric units per molecule. In certain embodiments, the polyisobutylene comprises an average of 26 to 53 isobutylene monomeric units per molecule. In certain embodiments, the polyisobutylene comprises an average of 26 to 52 isobutylene monomeric units per molecule. In certain embodiments, the polyisobutylene comprises an average of 26 to 51 isobutylene monomeric units per molecule. In certain embodiments, the polyisobutylene comprises an average of 26 to 50 isobutylene monomeric units per molecule. In certain embodiments, the polyisobutylene comprises an average of 26 to 48 isobutylene monomeric units per molecule. In certain embodiments, the polyisobutylene comprises an average of 26 to 46 isobutylene monomeric units per molecule. In certain embodiments, the polyisobutylene comprises an average of 26 to 44 isobutylene monomeric units per molecule. In certain embodiments, the polyisobutylene comprises an average of 26 to 42 isobutylene monomeric units per molecule. In certain embodiments, the polyisobutylene comprises an average of 26 to 40 isobutylene monomeric units per molecule. In certain embodiments, the polyisobutylene comprises an average of 26 to 38 isobutylene monomeric units per molecule. In certain embodiments, the polyisobutylene comprises an average of 26 to 36 isobutylene monomeric units per molecule. In certain embodiments, the polyisobutylene comprises an average of 26 to 34 isobutylene monomeric units per molecule. In certain embodiments, the polyisobutylene comprises an average of 26 to 32 isobutylene monomeric units per molecule. In certain embodiments, the polyisobutylene comprises an average of 26 to 30 isobutylene monomeric units per molecule. In certain embodiments, the polyisobutylene comprises an average of 26 to 28 isobutylene monomeric units per molecule. In certain embodiments, the polyisobutylene comprises an average of 28 to 56 isobutylene monomeric units per molecule. In certain embodiments, the polyisobutylene comprises an average of 28 to 55 isobutylene monomeric units per molecule. In certain embodiments, the polyisobutylene comprises an average of 28 to 54 isobutylene monomeric units per molecule. In certain embodiments, the polyisobutylene comprises an average of 28 to 53 isobutylene monomeric units per molecule. In certain embodiments, the polyisobutylene comprises an average of 28 to 52 isobutylene monomeric units per molecule. In certain embodiments, the polyisobutylene comprises an average of 28 to 51 isobutylene monomeric units per molecule. In certain embodiments, the polyisobutylene comprises an average of 28 to 50 isobutylene monomeric units per molecule. In certain embodiments, the polyisobutylene comprises an average of 28 to 48 isobutylene monomeric units per molecule. In certain embodiments, the polyisobutylene comprises an average of 28 to 46 isobutylene monomeric units per molecule. In certain embodiments, the polyisobutylene comprises an average of 28 to 44 isobutylene monomeric units per molecule. In certain embodiments, the polyisobutylene comprises an average of 28 to 42 isobutylene monomeric units per molecule. In certain embodiments, the polyisobutylene comprises an average of 28 to 40 isobutylene monomeric units per molecule. In certain embodiments, the polyisobutylene comprises an average of 28 to 38 isobutylene monomeric units per molecule. In certain embodiments, the polyisobutylene comprises an average of 28 to 36 isobutylene monomeric units per molecule. In certain embodiments, the polyisobutylene comprises an average of 28 to 34 isobutylene monomeric units per molecule. In certain embodiments, the polyisobutylene comprises an average of 28 to 32 isobutylene monomeric units per molecule. In certain embodiments, the polyisobutylene comprises an average of 28 to 30 isobutylene monomeric units per molecule. In certain embodiments, the polyisobutylene comprises an average of 30 to 56 isobutylene monomeric units per molecule. In certain embodiments, the polyisobutylene comprises an average of 30 to 55 isobutylene monomeric units per molecule. In certain embodiments, the polyisobutylene comprises an average of 30 to 54 isobutylene monomeric units per molecule. In certain embodiments, the polyisobutylene comprises an average of 30 to 53 isobutylene monomeric units per molecule. In certain embodiments, the polyisobutylene comprises an average of 30 to 52 isobutylene monomeric units per molecule. In certain embodiments, the polyisobutylene comprises an average of 30 to 51 isobutylene monomeric units per molecule. In certain embodiments, the polyisobutylene comprises an average of 30 to 50 isobutylene monomeric units per molecule. In certain embodiments, the polyisobutylene comprises an average of 30 to 48 isobutylene monomeric units per molecule. In certain embodiments, the polyisobutylene comprises an average of 30 to 46 isobutylene monomeric units per molecule. In certain embodiments, the polyisobutylene comprises an average of 30 to 44 isobutylene monomeric units per molecule. In certain embodiments, the polyisobutylene comprises an average of 30 to 42 isobutylene monomeric units per molecule. In certain embodiments, the polyisobutylene comprises an average of 30 to 40 isobutylene monomeric units per molecule. In certain embodiments, the polyisobutylene comprises an average of 30 to 38 isobutylene monomeric units per molecule. In certain embodiments, the polyisobutylene comprises an average of 30 to 36 isobutylene monomeric units per molecule. In certain embodiments, the polyisobutylene comprises an average of 30 to 34 isobutylene monomeric units per molecule. In certain embodiments, the polyisobutylene comprises an average of 30 to 32 isobutylene monomeric units per molecule. In certain embodiments, the polyisobutylene comprises an average of 32 to 56 isobutylene monomeric units per molecule. In certain embodiments, the polyisobutylene comprises an average of 32 to 55 isobutylene monomeric units per molecule. In certain embodiments, the polyisobutylene comprises an average of 32 to 54 isobutylene monomeric units per molecule. In certain embodiments, the polyisobutylene comprises an average of 32 to 53 isobutylene monomeric units per molecule. In certain embodiments, the polyisobutylene comprises an average of 32 to 52 isobutylene monomeric units per molecule. In certain embodiments, the polyisobutylene comprises an average of 32 to 51 isobutylene monomeric units per molecule. In certain embodiments, the polyisobutylene comprises an average of 32 to 50 isobutylene monomeric units per molecule. In certain embodiments, the polyisobutylene comprises an average of 32 to 48 isobutylene monomeric units per molecule. In certain embodiments, the polyisobutylene comprises an average of 32 to 46 isobutylene monomeric units per molecule. In certain embodiments, the polyisobutylene comprises an average of 32 to 44 isobutylene monomeric units per molecule. In certain embodiments, the polyisobutylene comprises an average of 32 to 42 isobutylene monomeric units per molecule. In certain embodiments, the polyisobutylene comprises an average of 32 to 40 isobutylene monomeric units per molecule. In certain embodiments, the polyisobutylene comprises an average of 32 to 38 isobutylene monomeric units per molecule. In certain embodiments, the polyisobutylene comprises an average of 32 to 36 isobutylene monomeric units per molecule. In certain embodiments, the polyisobutylene comprises an average of 32 to 34 isobutylene monomeric units per molecule. In certain embodiments, the polyisobutylene comprises an average of 34 to 56 isobutylene monomeric units per molecule. In certain embodiments, the polyisobutylene comprises an average of 34 to 55 isobutylene monomeric units per molecule. In certain embodiments, the polyisobutylene comprises an average of 34 to 54 isobutylene monomeric units per molecule. In certain embodiments, the polyisobutylene comprises an average of 34 to 53 isobutylene monomeric units per molecule. In certain embodiments, the polyisobutylene comprises an average of 34 to 52 isobutylene monomeric units per molecule. In certain embodiments, the polyisobutylene comprises an average of 34 to 51 isobutylene monomeric units per molecule. In certain embodiments, the polyisobutylene comprises an average of 34 to 50 isobutylene monomeric units per molecule. In certain embodiments, the polyisobutylene comprises an average of 34 to 48 isobutylene monomeric units per molecule. In certain embodiments, the polyisobutylene comprises an average of 34 to 46 isobutylene monomeric units per molecule. In certain embodiments, the polyisobutylene comprises an average of 34 to 44 isobutylene monomeric units per molecule. In certain embodiments, the polyisobutylene comprises an average of 34 to 42 isobutylene monomeric units per molecule. In certain embodiments, the polyisobutylene comprises an average of 34 to 40 isobutylene monomeric units per molecule. In certain embodiments, the polyisobutylene comprises an average of 34 to 38 isobutylene monomeric units per molecule. In certain embodiments, the polyisobutylene comprises an average of 34 to 36 isobutylene monomeric units per molecule. In certain embodiments, the polyisobutylene comprises an average of 36 to 56 isobutylene monomeric units per molecule. In certain embodiments, the polyisobutylene comprises an average of 36 to 55 isobutylene monomeric units per molecule. In certain embodiments, the polyisobutylene comprises an average of 36 to 54 isobutylene monomeric units per molecule. In certain embodiments, the polyisobutylene comprises an average of 36 to 53 isobutylene monomeric units per molecule. In certain embodiments, the polyisobutylene comprises an average of 36 to 52 isobutylene monomeric units per molecule. In certain embodiments, the polyisobutylene comprises an average of 36 to 51 isobutylene monomeric units per molecule. In certain embodiments, the polyisobutylene comprises an average of 36 to 50 isobutylene monomeric units per molecule. In certain embodiments, the polyisobutylene comprises an average of 36 to 48 isobutylene monomeric units per molecule. In certain embodiments, the polyisobutylene comprises an average of 36 to 46 isobutylene monomeric units per molecule. In certain embodiments, the polyisobutylene comprises an average of 36 to 44 isobutylene monomeric units per molecule. In certain embodiments, the polyisobutylene comprises an average of 36 to 42 isobutylene monomeric units per molecule. In certain embodiments, the polyisobutylene comprises an average of 36 to 40 isobutylene monomeric units per molecule. In certain embodiments, the polyisobutylene comprises an average of 36 to 38 isobutylene monomeric units per molecule. In certain embodiments, the polyisobutylene comprises an average of 38 to 56 isobutylene monomeric units per molecule. In certain embodiments, the polyisobutylene comprises an average of 38 to 55 isobutylene monomeric units per molecule. In certain embodiments, the polyisobutylene comprises an average of 38 to 54 isobutylene monomeric units per molecule. In certain embodiments, the polyisobutylene comprises an average of 38 to 53 isobutylene monomeric units per molecule. In certain embodiments, the polyisobutylene comprises an average of 38 to 52 isobutylene monomeric units per molecule. In certain embodiments, the polyisobutylene comprises an average of 38 to 51 isobutylene monomeric units per molecule. In certain embodiments, the polyisobutylene comprises an average of 38 to 50 isobutylene monomeric units per molecule. In certain embodiments, the polyisobutylene comprises an average of 38 to 48 isobutylene monomeric units per molecule. In certain embodiments, the polyisobutylene comprises an average of 38 to 46 isobutylene monomeric units per molecule. In certain embodiments, the polyisobutylene comprises an average of 38 to 44 isobutylene monomeric units per molecule. In certain embodiments, the polyisobutylene comprises an average of 38 to 42 isobutylene monomeric units per molecule. In certain embodiments, the polyisobutylene comprises an average of 38 to 40 isobutylene monomeric units per molecule. In certain embodiments, the polyisobutylene comprises an average of 40 to 56 isobutylene monomeric units per molecule. In certain embodiments, the polyisobutylene comprises an average of 40 to 55 isobutylene monomeric units per molecule. In certain embodiments, the polyisobutylene comprises an average of 40 to 54 isobutylene monomeric units per molecule. In certain embodiments, the polyisobutylene comprises an average of 40 to 53 isobutylene monomeric units per molecule. In certain embodiments, the polyisobutylene comprises an average of 40 to 52 isobutylene monomeric units per molecule. In certain embodiments, the polyisobutylene comprises an average of 40 to 51 isobutylene monomeric units per molecule. In certain embodiments, the polyisobutylene comprises an average of 40 to 50 isobutylene monomeric units per molecule. In certain embodiments, the polyisobutylene comprises an average of 40 to 48 isobutylene monomeric units per molecule. In certain embodiments, the polyisobutylene comprises an average of 40 to 46 isobutylene monomeric units per molecule. In certain embodiments, the polyisobutylene comprises an average of 40 to 44 isobutylene monomeric units per molecule. In certain embodiments, the polyisobutylene comprises an average of 40 to 42 isobutylene monomeric units per molecule. In certain embodiments, the polyisobutylene comprises an average of 42 to 56 isobutylene monomeric units per molecule. In certain embodiments, the polyisobutylene comprises an average of 42 to 55 isobutylene monomeric units per molecule. In certain embodiments, the polyisobutylene comprises an average of 42 to 54 isobutylene monomeric units per molecule. In certain embodiments, the polyisobutylene comprises an average of 42 to 53 isobutylene monomeric units per molecule. In certain embodiments, the polyisobutylene comprises an average of 42 to 52 isobutylene monomeric units per molecule. In certain embodiments, the polyisobutylene comprises an average of 42 to 51 isobutylene monomeric units per molecule. In certain embodiments, the polyisobutylene comprises an average of 42 to 50 isobutylene monomeric units per molecule. In certain embodiments, the polyisobutylene comprises an average of 42 to 48 isobutylene monomeric units per molecule. In certain embodiments, the polyisobutylene comprises an average of 42 to 46 isobutylene monomeric units per molecule. In certain embodiments, the polyisobutylene comprises an average of 42 to 44 isobutylene monomeric units per molecule. In certain embodiments, the polyisobutylene comprises an average of 44 to 56 isobutylene monomeric units per molecule. In certain embodiments, the polyisobutylene comprises an average of 44 to 55 isobutylene monomeric units per molecule. In certain embodiments, the polyisobutylene comprises an average of 44 to 54 isobutylene monomeric units per molecule. In certain embodiments, the polyisobutylene comprises an average of 44 to 53 isobutylene monomeric units per molecule. In certain embodiments, the polyisobutylene comprises an average of 44 to 52 isobutylene monomeric units per molecule. In certain embodiments, the polyisobutylene comprises an average of 44 to 51 isobutylene monomeric units per molecule. In certain embodiments, the polyisobutylene comprises an average of 44 to 50 isobutylene monomeric units per molecule. In certain embodiments, the polyisobutylene comprises an average of 44 to 48 isobutylene monomeric units per molecule. In certain embodiments, the polyisobutylene comprises an average of 44 to 46 isobutylene monomeric units per molecule. In certain embodiments, the polyisobutylene comprises an average of 46 to 56 isobutylene monomeric units per molecule. In certain embodiments, the polyisobutylene comprises an average of 46 to 55 isobutylene monomeric units per molecule. In certain embodiments, the polyisobutylene comprises an average of 46 to 54 isobutylene monomeric units per molecule. In certain embodiments, the polyisobutylene comprises an average of 46 to 53 isobutylene monomeric units per molecule. In certain embodiments, the polyisobutylene comprises an average of 46 to 52 isobutylene monomeric units per molecule. In certain embodiments, the polyisobutylene comprises an average of 46 to 51 isobutylene monomeric units per molecule. In certain embodiments, the polyisobutylene comprises an average of 46 to 50 isobutylene monomeric units per molecule. In certain embodiments, the polyisobutylene comprises an average of 46 to 48 isobutylene monomeric units per molecule. In certain embodiments, the polyisobutylene comprises an average of 48 to 56 isobutylene monomeric units per molecule. In certain embodiments, the polyisobutylene comprises an average of 48 to 55 isobutylene monomeric units per molecule. In certain embodiments, the polyisobutylene comprises an average of 48 to 54 isobutylene monomeric units per molecule. In certain embodiments, the polyisobutylene comprises an average of 48 to 53 isobutylene monomeric units per molecule. In certain embodiments, the polyisobutylene comprises an average of 48 to 52 isobutylene monomeric units per molecule. In certain embodiments, the polyisobutylene comprises an average of 48 to 51 isobutylene monomeric units per molecule. In certain embodiments, the polyisobutylene comprises an average of 48 to 50 isobutylene monomeric units per molecule. In certain embodiments, the polyisobutylene comprises an average of 50 to 56 isobutylene monomeric units per molecule. In certain embodiments, the polyisobutylene comprises an average of 50 to 55 isobutylene monomeric units per molecule. In certain embodiments, the polyisobutylene comprises an average of 50 to 54 isobutylene monomeric units per molecule. In certain embodiments, the polyisobutylene comprises an average of 50 to 53 isobutylene monomeric units per molecule. In certain embodiments, the polyisobutylene comprises an average of 50 to 52 isobutylene monomeric units per molecule. In certain embodiments, the polyisobutylene comprises an average of 50 to 51 isobutylene monomeric units per molecule. In certain embodiments, the polyisobutylene comprises an average of 51 to 56 isobutylene monomeric units per molecule. In certain embodiments, the polyisobutylene comprises an average of 51 to 55 isobutylene monomeric units per molecule. In certain embodiments, the polyisobutylene comprises an average of 51 to 54 isobutylene monomeric units per molecule. In certain embodiments, the polyisobutylene comprises an average of 51 to 53 isobutylene monomeric units per molecule. In certain embodiments, the polyisobutylene comprises an average of 51 to 52 isobutylene monomeric units per molecule. In certain embodiments, the polyisobutylene comprises an average of 52 to 56 isobutylene monomeric units per molecule. In certain embodiments, the polyisobutylene comprises an average of 52 to 55 isobutylene monomeric units per molecule. In certain embodiments, the polyisobutylene comprises an average of 52 to 54 isobutylene monomeric units per molecule. In certain embodiments, the polyisobutylene comprises an average of 52 to 53 isobutylene monomeric units per molecule. In certain embodiments, the polyisobutylene comprises an average of 53 to 56 isobutylene monomeric units per molecule. In certain embodiments, the polyisobutylene comprises an average of 53 to 55 isobutylene monomeric units per molecule. In certain embodiments, the polyisobutylene comprises an average of 53 to 54 isobutylene monomeric units per molecule. In certain embodiments, the polyisobutylene comprises an average of 54 to 56 isobutylene monomeric units per molecule. In certain embodiments, the polyisobutylene comprises an average of 54 to 55 isobutylene monomeric units per molecule. In certain embodiments, the polyisobutylene comprises an average of 55 to 56 isobutylene monomeric units per molecule. In certain embodiments, the polyisobutylene comprises an average of 3, 4, 5, 6, 7, 8, 9, 10, 12, 14, 16, 18, 20, 22, 24, 26, 28, 30, 32, 34, 36, 38, 40, 42, 44, 46, 48, 50, 51, 52, 53, 54, 55, or 56 isobutylene monomeric units per molecule.

In certain embodiments, the radical initiator may be any suitable radical initiator, and may comprise an organic peroxide initiator or a peracid initiator.

In certain embodiments, the organic peroxide initiator comprises diglutaroyl, dilauroyl peroxide, benzoyl peroxide, dicumyl peroxide, di(tert butyl) peroxide, tertbutyl hydroperoxide, 3,4-dimethyl-3,4-diphenyl-hexane, tert-butylperoxy-2-ethylhexanoate, tert-butylperoxy-benzoate, tert-butylperoxy-pivalate, tert-butylperoxy-3,5,5-trimethyl-hexanoate, di(2,4-dichlorobenzoyl) peroxide, di(2-methylbenzoyl) peroxide, or di(4-tert-butylcyclohexyl) peroxydicarbonate. Half lives of these and other radical initiators are widely available in the relevant scientific literature.

In certain embodiments, the ethylenically unsaturated acylating agent comprises at least one monoethylenically unsaturated C₃-C₂₈ monocarboxylic acid or ester thereof, or at least one C₄-C₂₈ dicarboxylic acid, anhydride or ester thereof.

In certain embodiments, the ethylenically unsaturated acylating agent may comprise one or more compounds falling within the following general formula:

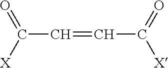

wherein X and X′ are the same or different, provided that at least one of X and X′ is a group that is capable of reacting to esterify alcohols, form amides or amine salts with ammonia or amines, form metal salts with reactive metals or basically reacting metal compounds and otherwise function as acylating agents. In certain embodiments, X and/or X′ is —OH, —O-hydrocarbyl, OM+ where M+ represents one equivalent of a metal, ammonium or amine cation, —NH₂, —Cl, —Br, and/or taken together X and X′ may be —O— so as to form an anhydride. In certain embodiments, X and X′ are such that both carboxylic functions can enter into acylation reactions. Suitable reactants include: maleic anhydride; monophenyl maleic anhydride; monomethyl, dimethyl, monochloro, monobromo, monofluoro, dichloro and difluoro maleic anhydride; N-phenylmaleimide and other substituted maleimides, isomaleimides; fumaric acid, maleic acid, alkyl hydrogen maleates and fumarates, dialkyl fumarates and maleates, fumaronilic acids and maleanic acids; and maleonitrile and fumaronitrile.

In certain embodiments, the monoethylenically unsaturated dicarboxylic acids or anhydrides of 3 to 28 carbon atoms may be selected from the group comprising maleic acid, fumaric acid, itaconic acid, mesaconic acid, methylenemalonic acid, citraconic acid, maleic anhydride, itaconic anhydride, citraconic anhydride and methylenemalonic anhydride and mixtures of these with one another.

In certain embodiments, the monoethylenically unsaturated C₃-C₂₈-monocarboxylic acids may be selected from the group comprising acrylic acid, methacrylic acid, dimethacrylic acid, ethylacrylic acid, crotonic acid, allylacetic acid and vinylacetic acid. Another group of suitable monomers is C₁-C₄₀ alkyl esters of monoethylenecially unsaturated C₃-C₁₀ mono- or dicarboxylic acids such as ethyl acrylate, butyl acrylate, 2-ethyl acrylate, decyl acrylate, docedyl acrylate, loctadecyl acrylate and the esters of industrial alcohol mixtures of 14 to 28 carbon atoms, ethyl methacrylate, 2-ethylhexyl methacrylate, decyl methacrylate, octadecyl methacrylate, monobutyl maleate, dibutyl maleate, monodecyl maleate, didodecyl maleate, monooctadecyl maleate, and dioctadecyl maleate.

In certain embodiments, the ethylenically unsaturated acylating agent comprises maleic acid, fumaric acid, itaconic acid, mesaconic acid, methylenemalonic acid, citraconic acid, maleic anhydride, itaconic anhydride, citraconic anhydride, or methylenemalonic anhydride.

In certain embodiments, the reaction product comprises at least one compound of the general formula I:

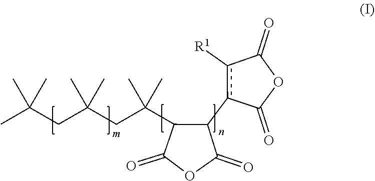

wherein:
each R¹ independently represents: —(CH₂)—(C(CH₂))—(CH₃); H; or is not present; wherein when R¹ is not present, the dashed double bond represents a double bond, and when R¹ is present, the dashed double bond represents a single bond;
each m independently is an integer from 1 to 54; and
each n independently is 0, 1 or 2.

In certain embodiments, each m independently is an integer from 1 to 53, from 1 to 52, from 1 to 51, from 1 to 50, from 1 to 49, from 1 to 48, from 1 to 46, from 1 to 44, from 1 to 42, from 1 to 40, from 1 to 38, from 1 to 36, from 1 to 34, from 1 to 32, from 1 to 30, from 1 to 28, from 1 to 26, from 1 to 24, from 1 to 22, from 1 to 20, from 1 to 18, from 1 to 16, from 1 to 14, from 1 to 12, from 1 to 10, from 1 to 8, from 1 to 7, from 1 to 6, from 1 to 5, from 1 to 4, from 1 to 3, from 1 to 2, from 2 to 54, from 2 to 53, from 2 to 52, from 2 to 51, from 2 to 50, from 2 to 49, from 2 to 48, from 2 to 46, from 2 to 44, from 2 to 42, from 2 to 40, from 2 to 38, from 2 to 36, from 2 to 34, from 2 to 32, from 2 to 30, from 2 to 28, from 2 to 26, from 2 to 24, from 2 to 22, from 2 to 20, from 2 to 18, from 2 to 16, from 2 to 14, from 2 to 12, from 2 to 10, from 2 to 8, from 2 to 7, from 2 to 6, from 2 to 5, from 2 to 4, from 2 to 3, from 3 to 54, from 3 to 53 from 3 to 52, from 3 to 51, from 3 to 50, from 3 to 49, from 3 to 48, from 3 to 46, from 3 to 44, from 3 to 42, from 3 to 40, from 3 to 38, from 3 to 36, from 3 to 34, from 3 to 32, from 3 to 30, from 3 to 28, from 3 to 26, from 3 to 24, from 3 to 22, from 3 to 20, from 3 to 18, from 3 to 16, from 3 to 14, from 3 to 12, from 3 to 10, from 3 to 8, from 3 to 7, from 3 to 6, from 3 to 5, from 3 to 4, from 4 to 54, from 4 to 53, from 4 to 52, from 4 to 51, from 4 to 50, from 4 to 49, from 4 to 48, from 4 to 46, from 4 to 44, from 4 to 42, from 4 to 40, from 4 to 38, from 4 to 36, from 4 to 34, from 4 to 32, from 4 to 30, from 4 to 28, from 4 to 26, from 4 to 24, from 4 to 22, from 4 to 20, from 4 to 18, from 4 to 16, from 4 to 14, from 4 to 12, from 4 to 10, from 4 to 8, from 4 to 7, from 4 to 6, from 4 to 5, from 5 to 54, from 5 to 53, from 5 to 52, from 5 to 51, from 5 to 50, from 5 to 49, from 5 to 48, from 5 to 46, from 5 to 44, from 5 to 42, from 5 to 40, from 5 to 38, from 5 to 36, from 5 to 34, from 5 to 32, from 5 to 30, from 5 to 28, from 5 to 26, from 5 to 24, from 5 to 22, from 5 to 20, from 5 to 18, from 5 to 16, from 5 to 14, from 5 to 12, from 5 to 10, from 5 to 8, from 5 to 7, from 5 to 6, from 6 to 54, from 6 to 53, from 6 to 52, from 6 to 51, from 6 to 50, from 6 to 49, from 6 to 48, from 6 to 46, from 6 to 44, from 6 to 42, from 6 to 40, from 6 to 38, from 6 to 36, from 6 to 34, from 6 to 32, from 6 to 30, from 6 to 28, from 6 to 26, from 6 to 24, from 6 to 22, from 6 to 20, from 6 to 18, from 6 to 16, from 6 to 14, from 6 to 12, from 6 to 10, from 6 to 8, from 6 to 7, from 7 to 54, from 7 to 53, from 7 to 52, from 7 to 51, from 7 to 50, from 7 to 49, from 7 to 48, from 7 to 46, from 7 to 44, from 7 to 42, from 7 to 40, from 7 to 38, from 7 to 36, from 7 to 34, from 7 to 32, from 7 to 30, from 7 to 28, from 7 to 26, from 7 to 24, from 7 to 22, from 7 to 20, from 7 to 18, from 7 to 16, from 7 to 14, from 7 to 12, from 7 to 10, from 7 to 8, from 8 to 54, from 8 to 53, from 8 to 52, from 8 to 51, from 8 to 50, from 8 to 49, from 8 to 48, from 8 to 46, from 8 to 44, from 8 to 42, from 8 to 40, from 8 to 38, from 8 to 36, from 8 to 34, from 8 to 32, from 8 to 30, from 8 to 28, from 8 to 26, from 8 to 24, from 8 to 22, from 8 to 20, from 8 to 18, from 8 to 16, from 8 to 14, from 8 to 12, from 8 to 10, from 10 to 54, from 10 to 53, from 10 to 52, from 10 to 51, from 10 to 50, from 10 to 49, from 10 to 48, from 10 to 46, from 10 to 44, from 10 to 42, from 10 to 40, from 10 to 38, from 10 to 36, from 10 to 34, from 10 to 32, from 10 to 30, from 10 to 28, from 10 to 26, from 10 to 24, from 10 to 22, from 10 to 20, from 10 to 18, from 10 to 16, from 10 to 14, from 10 to 12, from 12 to 54, from 12 to 53, from 12 to 52, from 12 to 51, from 12 to 50, from 12 to 49, from 12 to 48, from 12 to 46, from 12 to 44, from 12 to 42, from 12 to 40, from 12 to 38, from 12 to 36, from 12 to 34, from 12 to 32, from 12 to 30, from 12 to 28, from 12 to 26, from 12 to 24, from 12 to 22, from 12 to 20, from 12 to 18, from 12 to 16, from 12 to 14, from 14 to 54, from 14 to 53, from 14 to 52, from 14 to 51, from 14 to 50, from 14 to 49, from 14 to 48, from 14 to 46, from 14 to 44, from 14 to 42, from 14 to 40, from 14 to 38, from 14 to 36, from 14 to 34, from 14 to 32, from 14 to 30, from 14 to 28, from 14 to 26, from 14 to 24, from 14 to 22, from 14 to 20, from 14 to 18, from 14 to 16, from 16 to 54, from 16 to 53, from 16 to 52, from 16 to 51, from 16 to 50, from 16 to 49, from 16 to 48, from 16 to 46, from 16 to 44, from 16 to 42, from 16 to 40, from 16 to 38, from 16 to 36, from 16 to 34, from 16 to 32, from 16 to 30, from 16 to 28, from 16 to 26, from 16 to 24, from 16 to 22, from 16 to 20, from 16 to 18, from 18 to 54, from 18 to 53, from 18 to 52, from 18 to 51, from 18 to 50, from 18 to 49, from 18 to 48, from 18 to 46, from 18 to 44, from 18 to 42, from 18 to 40, from 18 to 38, from 18 to 36, from 18 to 34, from 18 to 32, from 18 to 30, from 18 to 28, from 18 to 26, from 18 to 24, from 18 to 22, from 18 to 20, from 20 to 54, from 20 to 53, from 20 to 52, from 20 to 51, from 20 to 50, from 20 to 49, from 20 to 48, from 20 to 46, from 20 to 44, from 20 to 42, from 20 to 40, from 20 to 38, from 20 to 36, from 20 to 34, from 20 to 32, from 20 to 30, from 20 to 28, from 20 to 26, from 20 to 24, from 20 to 22, from 22 to 54, from 22 to 53, from 22 to 52, from 22 to 51, from 22 to 50, from 22 to 49, from 22 to 48, from 22 to 46, from 22 to 44, from 22 to 42, from 22 to 40, from 22 to 38, from 22 to 36, from 22 to 34, from 22 to 32, from 22 to 30, from 22 to 28, from 22 to 26, from 22 to 24, from 24 to 54, from 24 to 53, from 24 to 52, from 24 to 51, from 24 to 50, from 24 to 49, from 24 to 48, from 24 to 46, from 24 to 44, from 24 to 42, from 24 to 40, from 24 to 38, from 24 to 36, from 24 to 34, from 24 to 32, from 24 to 30, from 24 to 28, from 24 to 26, from 26 to 54, from 26 to 53, from 26 to 52, from 26 to 51, from 26 to 50, from 26 to 49, from 26 to 48, from 26 to 46, from 26 to 44, from 26 to 42, from 26 to 40, from 26 to 38, from 26 to 36, from 26 to 34, from 26 to 32, from 26 to 30, from 26 to 28, from 28 to 54, from 28 to 53, from 28 to 52, from 28 to 51, from 28 to 50, from 28 to 49, from 28 to 48, from 28 to 46, from 28 to 44, from 28 to 42, from 28 to 40, from 28 to 38, from 28 to 36, from 28 to 34, from 28 to 32, from 28 to 30, from 30 to 54, from 30 to 53, from 30 to 52, from 30 to 51, from 30 to 50, from 30 to 49, from 30 to 48, from 30 to 46, from 30 to 44, from 30 to 42, from 30 to 40, from 30 to 38, from 30 to 36, from 30 to 34, from 30 to 32, from 32 to 54, from 32 to 53, from 32 to 52, from 32 to 51, from 32 to 50, from 32 to 49, from 32 to 48, from 32 to 46, from 32 to 44, from 32 to 42, from 32 to 40, from 32 to 38, from 32 to 36, from 32 to 34, from 34 to 54, from 34 to 53, from 34 to 52, from 34 to 51, from 34 to 50, from 34 to 49, from 34 to 48, from 34 to 46, from 34 to 44, from 34 to 42, from 34 to 40, from 34 to 38, from 34 to 36, from 36 to 54, from 36 to 53, from 36 to 52, from 36 to 51, from 36 to 50, from 36 to 49, from 36 to 48, from 36 to 46, from 36 to 44, from 36 to 42, from 36 to 40, from 36 to 38, from 38 to 54, from 38 to 53, from 38 to 52, from 38 to 51, from 38 to 50, from 38 to 49, from 38 to 48, from 38 to 46, from 38 to 44, from 38 to 42, from 38 to 40, from 40 to 54, from 40 to 53, from 40 to 52, from 40 to 51, from 40 to 50, from 40 to 49, from 40 to 48, from 40 to 46, from 40 to 44, from 40 to 42, from 42 to 54, from 42 to 53, from 42 to 52, from 42 to 51, from 42 to 50, from 42 to 49, from 42 to 48, from 42 to 46, from 42 to 44, from 44 to 54, from 44 to 53, from 44 to 52, from 44 to 51, from 44 to 50, from 44 to 49, from 44 to 48, from 44 to 46, from 46 to 54, from 46 to 53, from 46 to 52, from 46 to 51, from 46 to 50, from 46 to 49, from 46 to 48, from 48 to 54, from 48 to 53, from 48 to 52, from 48 to 51, from 48 to 50, from 48 to 49, from 49 to 54, from 49 to 53, from 49 to 52, from 49 to 51, from 49 to 50, from 50 to 54, from 50 to 53, from 50 to 52, from 50 to 51, from 51 to 54, from 51 to 53, from 51 to 52, from 51 to 51, from 52 to 54, from 52 to 53, or from 53 to 54. In certain embodiments, each m independently is 1, 2, 3, 4, 5, 6, 7, 8, 10, 12, 14, 16, 18, 20, 22, 24, 26, 28, 30, 32, 34, 36, 38, 40, 42, 44, 46, 48, 49, 50, 51, 52, 53, or 54.

In certain embodiments, the reaction product comprises at least 30 (such as at least 35, 40, 45, 50, 55, 60, 65, 70, 75, 80, 85, 90, 95, or 99) mol % of the at least one compound of the general formula I. In certain embodiments, the reaction product comprises from 30 to 100 (such as from 35 to 100, from 40 to 100, from 45 to 100, from 50 to 100, from 55 to 100, from 60 to 100, from 65 to 100, from 70 to 100, from 75 to 100, from 80 to 100, from 85 to 100, from 90 to 100, from 95 to 100, from 99 to 100, from 30 to 99, from 35 to 99, from 40 to 99, from 45 to 99, from 50 to 99, from 55 to 99, from 60 to 99, from 65 to 99, from 70 to 99, from 75 to 99, from 80 to 99, from 85 to 99, from 90 to 99, from 95 to 99, from 30 to 95, from 35 to 95, from 40 to 95, from 45 to 95, from 50 to 95, from 55 to 95, from 60 to 95, from 65 to 95, from 70 to 95, from 75 to 95, from 80 to 95, from 85 to 95, from 90 to 95, from 30 to 90, from 35 to 90, from 40 to 90, from 45 to 90, from 50 to 90, from 55 to 90, from 60 to 90, from 65 to 90, from 70 to 90, from 75 to 90, from 80 to 90, from 85 to 90, from 30 to 85, from 35 to 85, from 40 to 85, from 45 to 85, from 50 to 85, from 55 to 85, from 60 to 85, from 65 to 85, from 70 to 85, from 75 to 85, from 80 to 85, from 30 to 80, from 35 to 80, from 40 to 80, from 45 to 80, from 50 to 80, from 55 to 80, from 60 to 80, from 65 to 80, from 70 to 80, from 75 to 80, from 30 to 75, from 35 to 75, from 40 to 75, from 45 to 75, from 50 to 75, from 55 to 75, from 60 to 75, from 65 to 75, from 70 to 75, from 30 to 70, from 35 to 70, from 40 to 70, from 45 to 70, from 50 to 70, from 55 to 70, from 60 to 70, from 65 to 70, from 30 to 65, from 35 to 65, from 40 to 65, from 45 to 65, from 50 to 65, from 55 to 65, from 60 to 65, from 30 to 60, from 35 to 60, from 40 to 60, from 45 to 60, from 50 to 60, from 55 to 60, from 30 to 55, from 35 to 55, from 40 to 55, from 45 to 55, from 50 to 55, from 30 to 50, from 35 to 50, from 40 to 50, from 45 to 50, from 30 to 45, from 35 to 45, from 40 to 45, from 30 to 40, from 35 to 40 or from 30 to 35) mol % of the at least one compound of the general formula I.

In certain embodiments, the reaction product comprises less than 40 (such as less than 35, 30, 25, 20, 15, 14, 13, 12, 11, 10, 9, 8, 7, 6, 5, 4, 3, 2, or 1) weight percent unreacted polyisobutylene. In certain embodiments, the reaction produce comprises from 0 to 40 (such as from 0 to 35, from 0 to 30, from 0 to 25, from 0 to 20, from 0 to 15, from 0 to 14, from 0 to 13, from 0 to 12, from 0 to 11, from 0 to 10, from 0 to 9, from 0 to 8, from 0 to 7, from 0 to 6, from 0 to 5, from 0 to 4, from 0 to 3, from 0 to 2, from 0 to 1, from greater than 0 to 40, from greater than 0 to 35, from greater than 0 to 30, from greater than 0 to 25, from greater than 0 to 20, from greater than 0 to 15, from greater than 0 to 14, from greater than 0 to 13, from greater than 0 to 12, from greater than 0 to 11, from greater than 0 to 10, from greater than 0 to 9, from greater than 0 to 8, from greater than 0 to 7, from greater than 0 to 6, from greater than 0 to 5, from greater than 0 to 4, from greater than 0 to 3, from greater than 0 to 2, from greater than 0 to 1, from greater than 0 to 35, from 1 to 40, from 1 to 35, from 1 to 30, from 1 to 25, from 1 to 20, from 1 to 15, from 1 to 14, from 1 to 13, from 1 to 12, from 1 to 11, from 1 to 10, from 1 to 9, from 1 to 8, from 1 to 7, from 1 to 6, from 1 to 5, from 1 to 4, from 1 to 3, from 1 to 2, from 2 to 40, from 2 to 35, from 2 to 30, from 2 to 25, from 2 to 20, from 2 to 15, from 2 to 14, from 2 to 13, from 2 to 12, from 2 to 11, from 2 to 10, from 2 to 9, from 2 to 8, from 2 to 7, from 2 to 6, from 2 to 5, from 2 to 4, from 2 to 3, from 3 to 40, from 3 to 35, from 3 to 30, from 3 to 25, from 3 to 20, from 3 to 15, from 3 to 14, from 3 to 13, from 3 to 12, from 3 to 11, from 3 to 10, from 3 to 9, from 3 to 8, from 3 to 7, from 3 to 6, from 3 to 5, from 3 to 4, from 4 to 40, from 4 to 35, from 4 to 30, from 4 to 25, from 4 to 20, from 4 to 15, from 4 to 14, from 4 to 13, from 4 to 12, from 4 to 11, from 4 to 10, from 4 to 9, from 4 to 8, from 4 to 7, from 4 to 6, from 4 to 5, from 5 to 40, from 5 to 35, from 5 to 30, from 5 to 25, from 5 to 20, from 5 to 15, from 5 to 14, from 5 to 13, from 5 to 12, from 5 to 11, from 5 to 10, from 5 to 9, from 5 to 8, from 5 to 7, from 5 to 6, from 6 to 40, from 6 to 35, from 6 to 30, from 6 to 25, from 6 to 20, from 6 to 15, from 6 to 14, from 6 to 13, from 6 to 12, from 6 to 11, from 6 to 10, from 6 to 9, from 6 to 8, from 6 to 7, from 7 to 40, from 7 to 35, from 7 to 30, from 7 to 25, from 7 to 20, from 7 to 15, from 7 to 14, from 7 to 13, from 7 to 12, from 7 to 11, from 7 to 10, from 7 to 9, from 7 to 8, from 8 to 40, from 8 to 35, from 8 to 30, from 8 to 25, from 8 to 20, from 8 to 15, from 8 to 14, from 8 to 13, from 8 to 12, from 8 to 11, from 8 to 10, from 8 to 9, from 9 to 40, from 9 to 35, from 9 to 30, from 9 to 25, from 9 to 20, from 9 to 15, from 9 to 14, from 9 to 13, from 9 to 12, from 9 to 11, from 9 to 10, from 10 to 40, from 10 to 35, from 10 to 30, from 10 to 25, from 10 to 20, from 10 to 15, from 10 to 14, from 10 to 13, from 10 to 12, from 10 to 11, from 11 to 40, from 11 to 35, from 11 to 30, from 11 to 25, from 11 to 20, from 11 to 15, from 11 to 14, from 11 to 13, from 11 to 12, from 12 to 40, from 12 to 35, from 12 to 30, from 12 to 25, from 12 to 20, from 12 to 15, from 12 to 14, from 12 to 13, from 13 to 40, from 13 to 35, from 13 to 30, from 13 to 25, from 13 to 20, from 13 to 15, from 13 to 14, from 14 to 40, from 14 to 35, from 14 to 30, from 14 to 25, from 14 to 20, from 14 to 15, from 15 to 40, from 15 to 35, from 15 to 30, from 15 to 25, from 15 to 20, from 20 to 40, from 20 to 35, from 20 to 30, from 20 to 25, from 25 to 40, from 25 to 35, from 25 to 30, from 30 to 40, from 30 to 35, or from 35 to 40) weight percent unreacted polyisobutylene.

Also provided are embodiments of the processes described above, wherein the process comprises reacting polyisobutylene with a radical initiator and an ethylenically unsaturated acylating agent in two or more additions at a reaction temperature of from 150° C. to 225° C. to produce the reaction product. In certain embodiments, the radical initiator and the ethylenically unsaturated acylating agent are added in two to ten additions (such as two to nine, two to eight, two to seven, two to six, two to five, two to four, two to three, or three additions).

In certain embodiments, each of the two or more additions independently comprises at least 5 (such as at least 10, 15, 20, 25, 30, 35, 40, 45, or 50) weight percent of the total amount of the radical initiator and/or at least 5 (such as at least 10, 15, 20, 25, 30, 35, 40, 45, or 50) weight percent of the total amount of the ethylenically unsaturated acylating agent to be reacted with the polyisobutylene. In certain embodiments, each of the two or more additions independently comprises at most 95 (such as at most 90, 85, 80, 75, 70, 65, 60, 55, 50, 45, 40, 35, 30, 25, 20, 15 or 10) weight percent of the total amount of the radical initiator and/or at most 95 (such as at most 90, 85, 80, 75, 70, 65, 60, 55, 50, 45, 40, 35, 30, 25, 20, 15 or 10) weight percent of the total amount of the ethylenically unsaturated acylating agent to be reacted with the polyisobutylene. In certain embodiments, each of the two or more additions independently comprises from 5 to 95 (such as from 5 to 90, from 5 to 85, from 5 to 80, from 5 to 75, from 5 to 70, from 5 to 65, from 5 to 60, from 5 to 55, from 5 to 50, from 5 to 45, from 5 to 40, from 5 to 35, from 5 to 30, from 5 to 25, from 5 to 20, from 5 to 15, from 5 to 10, from 10 to 95, from 10 to 90, from 10 to 85, from 10 to 80, from 10 to 75, from 10 to 70, from 10 to 65, from 10 to 60, from 10 to 55, from 10 to 50, from 10 to 45, from 10 to 40, from 10 to 35, from 10 to 30, from 10 to 25, from 10 to 20, from 10 to 15, from 15 to 95, from 15 to 90, from 15 to 85, from 15 to 80, from 15 to 75, from 15 to 70, from 15 to 65, from 15 to 60, from 15 to 55, from 15 to 50, from 15 to 45, from 15 to 40, from 15 to 35, from 15 to 30, from 15 to 25, from 15 to 20, from 20 to 95, from 20 to 90, from 20 to 85, from 20 to 80, from 20 to 75, from 20 to 70, from 20 to 65, from 20 to 60, from 20 to 55, from 20 to 50, from 20 to 45, from 20 to 40, from 20 to 35, from 20 to 30, from 20 to 25, from 25 to 95, from 25 to 90, from 25 to 85, from 25 to 80, from 25 to 75, from 25 to 70, from 25 to 65, from 25 to 60, from 25 to 55, from 25 to 50, from 25 to 45, from 25 to 40, from 25 to 35, from 25 to 30, from 30 to 95, from 30 to 90, from 30 to 85, from 30 to 80, from 30 to 75, from 30 to 70, from 30 to 65, from 30 to 60, from 30 to 55, from 30 to 50, from 30 to 45, from 30 to 40, from 30 to 35, from 35 to 95, from 35 to 90, from 35 to 85, from 35 to 80, from 35 to 75, from 35 to 70, from 35 to 65, from 35 to 60, from 35 to 55, from 35 to 50, from 35 to 45, from 35 to 40, from 40 to 95, from 40 to 90, from 40 to 85, from 40 to 80, from 40 to 75, from 40 to 70, from 40 to 65, from 40 to 60, from 40 to 55, from 40 to 50, from 40 to 45, from 45 to 95, from 45 to 90, from 45 to 85, from 45 to 80, from 45 to 75, from 45 to 70, from 45 to 65, from 45 to 60, from 45 to 45, from 45 to 50, from 50 to 95, from 50 to 90, from 50 to 85, from 50 to 80, from 50 to 75, from 50 to 70, from 50 to 65, from 50 to 60, or from 50 to 55) weight percent of the total amount of the radical initiator and/or from 5 to 95 (such as from 5 to 90, from 5 to 85, from 5 to 80, from 5 to 75, from 5 to 70, from 5 to 65, from 5 to 60, from 5 to 55, from 5 to 50, from 5 to 45, from 5 to 40, from 5 to 35, from 5 to 30, from 5 to 25, from 5 to 20, from 5 to 15, from 5 to 10, from 10 to 95, from 10 to 90, from 10 to 85, from 10 to 80, from 10 to 75, from 10 to 70, from 10 to 65, from 10 to 60, from 10 to 55, from 10 to 50, from 10 to 45, from 10 to 40, from 10 to 35, from 10 to 30, from 10 to 25, from 10 to 20, from 10 to 15, from 15 to 95, from 15 to 90, from 15 to 85, from 15 to 80, from 15 to 75, from 15 to 70, from 15 to 65, from 15 to 60, from 15 to 55, from 15 to 50, from 15 to 45, from 15 to 40, from 15 to 35, from 15 to 30, from 15 to 25, from 15 to 20, from 20 to 95, from 20 to 90, from 20 to 85, from 20 to 80, from 20 to 75, from 20 to 70, from 20 to 65, from 20 to 60, from 20 to 55, from 20 to 50, from 20 to 45, from 20 to 40, from 20 to 35, from 20 to 30, from 20 to 25, from 25 to 95, from 25 to 90, from 25 to 85, from 25 to 80, from 25 to 75, from 25 to 70, from 25 to 65, from 25 to 60, from 25 to 55, from 25 to 50, from 25 to 45, from 25 to 40, from 25 to 35, from 25 to 30, from 30 to 95, from 30 to 90, from 30 to 85, from 30 to 80, from 30 to 75, from 30 to 70, from 30 to 65, from 30 to 60, from 30 to 55, from 30 to 50, from 30 to 45, from 30 to 40, from 30 to 35, from 35 to 95, from 35 to 90, from 35 to 85, from 35 to 80, from 35 to 75, from 35 to 70, from 35 to 65, from 35 to 60, from 35 to 55, from 35 to 50, from 35 to 45, from 35 to 40, from 40 to 95, from 40 to 90, from 40 to 85, from 40 to 80, from 40 to 75, from 40 to 70, from 40 to 65, from 40 to 60, from 40 to 55, from 40 to 50, from 40 to 45, from 45 to 95, from 45 to 90, from 45 to 85, from 45 to 80, from 45 to 75, from 45 to 70, from 45 to 65, from 45 to 60, from 45 to 45, from 45 to 50, from 50 to 95, from 50 to 90, from 50 to 85, from 50 to 80, from 50 to 75, from 50 to 70, from 50 to 65, from 50 to 60, or from 50 to 55) weight percent of the total amount of the ethylenically unsaturated acylating agent to be reacted with the polyisobutylene.

In certain embodiments, at least two of the two or more additions are separated in time by at least the half-life of the radical initiator. In certain embodiments, at least two of the two or more additions are separated in time by at least 1.1 (such as at least 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.2, 4.4, 4.6, 4.8, 5, 5.5, 6, 6.5, 7, 7.5, 8, 8.5, 9, 9.5 or 10) times the half-life of the radical initiator. In certain embodiments, each of the two or more additions are separated in times by from 1 to 10 (such as from 1.1 to 10, from 1.2 to 10, from 1.3 to 10, from 1.4 to 10, from 1.5 to 10, from 1.6 to 10, from 1.7 to 10, from 1.8 to 10, from 1.9 to 10, from 2 to 10, from 2.1 to 10, from 2.2 to 10, from 2.3 to 10, from 2.4 to 10, from 2.5 to 10, from 2.6 to 10, from 2.7 to 10, from 2.8 to 10, from 2.9 to 10, from 3 to 10, from 3.1 to 10, from 3.2 to 10, from 3.3 to 10, from 3.4 to 10, from 3.5 to 10, from 3.6 to 10, from 3.7 to 10, from 3.8 to 10, from 3.9 to 10, from 4 to 10, from 4.2 to 10, from 4.4 to 10, from 4.6 to 10, from 4.8 to 10, from 5 to 10, from 5.5 to 10, from 6 to 10, from 6.5 to 10, from 7 to 10, from 7.5 to 10, from 8 to 10, from 8.5 to 10, from 9 to 10, from 9.5 to 10, from 1 to 9.5, from 1.1 to 9.5, from 1.2 to 9.5, from 1.3 to 9.5, from 1.4 to 9.5, from 1.5 to 9.5, from 1.6 to 9.5, from 1.7 to 9.5, from 1.8 to 9.5, from 1.9 to 9.5, from 2 to 9.5, from 2.1 to 9.5, from 2.2 to 9.5, from 2.3 to 9.5, from 2.4 to 9.5, from 2.5 to 9.5, from 2.6 to 9.5, from 2.7 to 9.5, from 2.8 to 9.5, from 2.9 to 9.5, from 3 to 9.5, from 3.1 to 9.5, from 3.2 to 9.5, from 3.3 to 9.5, from 3.4 to 9.5, from 3.5 to 9.5, from 3.6 to 9.5, from 3.7 to 9.5, from 3.8 to 9.5, from 3.9 to 9.5, from 4 to 9.5, from 4.2 to 9.5, from 4.4 to 9.5, from 4.6 to 9.5, from 4.8 to 9.5, from 5 to 9.5, from 5.5 to 9.5, from 6 to 9.5, from 6.5 to 9.5, from 7 to 9.5, from 7.5 to 9.5, from 8 to 9.5, from 8.5 to 9.5, from 9 to 9.5, from 1 to 9, from 1.1 to 9, from 1.2 to 9, from 1.3 to 9, from 1.4 to 9, from 1.5 to 9, from 1.6 to 9, from 1.7 to 9, from 1.8 to 9, from 1.9 to 9, from 2 to 9, from 2.1 to 9, from 2.2 to 9, from 2.3 to 9, from 2.4 to 9, from 2.5 to 9, from 2.6 to 9, from 2.7 to 9, from 2.8 to 9, from 2.9 to 9, from 3 to 9, from 3.1 to 9, from 3.2 to 9, from 3.3 to 9, from 3.4 to 9, from 3.5 to 9, from 3.6 to 9, from 3.7 to 9, from 3.8 to 9, from 3.9 to 9, from 4 to 9, from 4.2 to 9, from 4.4 to 9, from 4.6 to 9, from 4.8 to 9, from 5 to 9, from 5.5 to 9, from 6 to 9, from 6.5 to 9, from 7 to 9, from 7.5 to 9, from 8 to 9, from 8.5 to 9, from 1 to 8.5, from 1.1 to 8.5, from 1.2 to 8.5, from 1.3 to 8.5, from 1.4 to 8.5, from 1.5 to 8.5, from 1.6 to 8.5, from 1.7 to 8.5, from 1.8 to 8.5, from 1.9 to 8.5, from 2 to 8.5, from 2.1 to 8.5, from 2.2 to 8.5, from 2.3 to 8.5, from 2.4 to 8.5, from 2.5 to 8.5, from 2.6 to 8.5, from 2.7 to 8.5, from 2.8 to 8.5, from 2.9 to 8.5, from 3 to 8.5, from 3.1 to 8.5, from 3.2 to 8.5, from 3.3 to 8.5, from 3.4 to 8.5, from 3.5 to 8.5, from 3.6 to 8.5, from 3.7 to 8.5, from 3.8 to 8.5, from 3.9 to 8.5, from 4 to 8.5, from 4.2 to 8.5, from 4.4 to 8.5, from 4.6 to 8.5, from 4.8 to 8.5, from 5 to 8.5, from 5.5 to 8.5, from 6 to 8.5, from 6.5 to 8.5, from 7 to 8.5, from 7.5 to 8.5, from 8 to 8.5, from 1 to 8, from 1.1 to 8, from 1.2 to 8, from 1.3 to 8, from 1.4 to 8, from 1.5 to 8, from 1.6 to 8, from 1.7 to 8, from 1.8 to 8, from 1.9 to 8, from 2 to 8, from 2.1 to 8, from 2.2 to 8, from 2.3 to 8, from 2.4 to 8, from 2.5 to 8, from 2.6 to 8, from 2.7 to 8, from 2.8 to 8, from 2.9 to 8, from 3 to 8, from 3.1 to 8, from 3.2 to 8, from 3.3 to 8, from 3.4 to 8, from 3.5 to 8, from 3.6 to 8, from 3.7 to 8, from 3.8 to 8, from 3.9 to 8, from 4 to 8, from 4.2 to 8, from 4.4 to 8, from 4.6 to 8, from 4.8 to 8, from 5 to 8, from 5.5 to 8, from 6 to 8, from 6.5 to 8, from 7 to 8, from 7.5 to 8, from 1 to 7.5, from 1.1 to 7.5, from 1.2 to 7.5, from 1.3 to 7.5, from 1.4 to 7.5, from 1.5 to 7.5, from 1.6 to 7.5, from 1.7 to 7.5, from 1.8 to 7.5, from 1.9 to 7.5, from 2 to 7.5, from 2.1 to 7.5, from 2.2 to 7.5, from 2.3 to 7.5, from 2.4 to 7.5, from 2.5 to 7.5, from 2.6 to 7.5, from 2.7 to 7.5, from 2.8 to 7.5, from 2.9 to 7.5, from 3 to 7.5, from 3.1 to 7.5, from 3.2 to 7.5, from 3.3 to 7.5, from 3.4 to 7.5, from 3.5 to 7.5, from 3.6 to 7.5, from 3.7 to 7.5, from 3.8 to 7.5, from 3.9 to 7.5, from 4 to 7.5, from 4.2 to 7.5, from 4.4 to 7.5, from 4.6 to 7.5, from 4.8 to 7.5, from 5 to 7.5, from 5.5 to 7.5, from 6 to 7.5, from 6.5 to 7.5, from 7 to 7.5, from 1 to 7, from 1.1 to 7, from 1.2 to 7, from 1.3 to 7, from 1.4 to 7, from 1.5 to 7, from 1.6 to 7, from 1.7 to 7, from 1.8 to 7, from 1.9 to 7, from 2 to 7, from 2.1 to 7, from 2.2 to 7, from 2.3 to 7, from 2.4 to 7, from 2.5 to 7, from 2.6 to 7, from 2.7 to 7, from 2.8 to 7, from 2.9 to 7, from 3 to 7, from 3.1 to 7, from 3.2 to 7, from 3.3 to 7, from 3.4 to 7, from 3.5 to 7, from 3.6 to 7, from 3.7 to 7, from 3.8 to 7, from 3.9 to 7, from 4 to 7, from 4.2 to 7, from 4.4 to 7, from 4.6 to 7, from 4.8 to 7, from 5 to 7, from 5.5 to 7, from 6 to 7, from 6.5 to 7, from 1 to 6.5, from 1.1 to 6.5, from 1.2 to 6.5, from 1.3 to 6.5, from 1.4 to 6.5, from 1.5 to 6.5, from 1.6 to 6.5, from 1.7 to 6.5, from 1.8 to 6.5, from 1.9 to 6.5, from 2 to 6.5, from 2.1 to 6.5, from 2.2 to 6.5, from 2.3 to 6.5, from 2.4 to 6.5, from 2.5 to 6.5, from 2.6 to 6.5, from 2.7 to 6.5, from 2.8 to 6.5, from 2.9 to 6.5, from 3 to 6.5, from 3.1 to 6.5, from 3.2 to 6.5, from 3.3 to 6.5, from 3.4 to 6.5, from 3.5 to 6.5, from 3.6 to 6.5, from 3.7 to 6.5, from 3.8 to 6.5, from 3.9 to 6.5, from 4 to 6.5, from 4.2 to 6.5, from 4.4 to 6.5, from 4.6 to 6.5, from 4.8 to 6.5, from 5 to 6.5, from 5.5 to 6.5, from 6 to 6.5, from 1 to 6, from 1.1 to 6, from 1.2 to 6, from 1.3 to 6, from 1.4 to 6, from 1.5 to 6, from 1.6 to 6, from 1.7 to 6, from 1.8 to 6, from 1.9 to 6, from 2 to 6, from 2.1 to 6, from 2.2 to 6, from 2.3 to 6, from 2.4 to 6, from 2.5 to 6, from 2.6 to 6, from 2.7 to 6, from 2.8 to 6, from 2.9 to 6, from 3 to 6, from 3.1 to 6, from 3.2 to 6, from 3.3 to 6, from 3.4 to 6, from 3.5 to 6, from 3.6 to 6, from 3.7 to 6, from 3.8 to 6, from 3.9 to 6, from 4 to 6, from 4.2 to 6, from 4.4 to 6, from 4.6 to 6, from 4.8 to 6, from 5 to 6, from 5.5 to 6, from 1 to 5.5, from 1.1 to 5.5, from 1.2 to 5.5, from 1.3 to 5.5, from 1.4 to 5.5, from 1.5 to 5.5, from 1.6 to 5.5, from 1.7 to 5.5, from 1.8 to 5.5, from 1.9 to 5.5, from 2 to 5.5, from 2.1 to 5.5, from 2.2 to 5.5, from 2.3 to 5.5, from 2.4 to 5.5, from 2.5 to 5.5, from 2.6 to 5.5, from 2.7 to 5.5, from 2.8 to 5.5, from 2.9 to 5.5, from 3 to 5.5, from 3.1 to 5.5, from 3.2 to 5.5, from 3.3 to 5.5, from 3.4 to 5.5, from 3.5 to 5.5, from 3.6 to 5.5, from 3.7 to 5.5, from 3.8 to 5.5, from 3.9 to 5.5, from 4 to 5.5, from 4.2 to 5.5, from 4.4 to 5.5, from 4.6 to 5.5, from 4.8 to 5.5, from 5 to 5.5, from 1 to 5, from 1.1 to 5, from 1.2 to 5, from 1.3 to 5, from 1.4 to 5, from 1.5 to 5, from 1.6 to 5, from 1.7 to 5, from 1.8 to 5, from 1.9 to 5, from 2 to 5, from 2.1 to 5, from 2.2 to 5, from 2.3 to 5, from 2.4 to 5, from 2.5 to 5, from 2.6 to 5, from 2.7 to 5, from 2.8 to 5, from 2.9 to 5, from 3 to 5, from 3.1 to 5, from 3.2 to 5, from 3.3 to 5, from 3.4 to 5, from 3.5 to 5, from 3.6 to 5, from 3.7 to 5, from 3.8 to 5, from 3.9 to 5, from 4 to 5, from 4.2 to 5, from 4.4 to 5, from 4.6 to 5, from 4.8 to 5, from 1 to 4.8, from 1.1 to 4.8, from 1.2 to 4.8, from 1.3 to 4.8, from 1.4 to 4.8, from 1.5 to 4.8, from 1.6 to 4.8, from 1.7 to 4.8, from 1.8 to 4.8, from 1.9 to 4.8, from 2 to 4.8, from 2.1 to 4.8, from 2.2 to 4.8, from 2.3 to 4.8, from 2.4 to 4.8, from 2.5 to 4.8, from 2.6 to 4.8, from 2.7 to 4.8, from 2.8 to 4.8, from 2.9 to 4.8, from 3 to 4.8, from 3.1 to 4.8, from 3.2 to 4.8, from 3.3 to 4.8, from 3.4 to 4.8, from 3.5 to 4.8, from 3.6 to 4.8, from 3.7 to 4.8, from 3.8 to 4.8, from 3.9 to 4.8, from 4 to 4.8, from 4.2 to 4.8, from 4.4 to 4.8, from 4.6 to 4.8, from 1. to 4.6, from 1.1 to 4.6, from 1.2 to 4.6, from 1.3 to 4.6, from 1.4 to 4.6, from 1.5 to 4.6, from 1.6 to 4.6, from 1.7 to 4.6, from 1.8 to 4.6, from 1.9 to 4.6, from 2 to 4.6, from 2.1 to 4.6, from 2.2 to 4.6, from 2.3 to 4.6, from 2.4 to 4.6, from 2.5 to 4.6, from 2.6 to 4.6, from 2.7 to 4.6, from 2.8 to 4.6, from 2.9 to 4.6, from 3 to 4.6, from 3.1 to 4.6, from 3.2 to 4.6, from 3.3 to 4.6, from 3.4 to 4.6, from 3.5 to 4.6, from 3.6 to 4.6, from 3.7 to 4.6, from 3.8 to 4.6, from 3.9 to 4.6, from 4 to 4.6, from 4.2 to 4.6, from 4.4 to 4.6, from 1 to 4.4, from 1.1 to 4.4, from 1.2 to 4.4, from 1.3 to 4.4, from 1.4 to 4.4, from 1.5 to 4.4, from 1.6 to 4.4, from 1.7 to 4.4, from 1.8 to 4.4, from 1.9 to 4.4, from 2 to 4.4, from 2.1 to 4.4, from 2.2 to 4.4, from 2.3 to 4.4, from 2.4 to 4.4, from 2.5 to 4.4, from 2.6 to 4.4, from 2.7 to 4.4, from 2.8 to 4.4, from 2.9 to 4.4, from 3 to 4.4, from 3.1 to 4.4, from 3.2 to 4.4, from 3.3 to 4.4, from 3.4 to 4.4, from 3.5 to 4.4, from 3.6 to 4.4, from 3.7 to 4.4, from 3.8 to 4.4, from 3.9 to 4.4, from 4 to 4.4, from 4.2 to 4.4, from 1 to 4.2, from 1.1 to 4.2, from 1.2 to 4.2, from 1.3 to 4.2, from 1.4 to 4.2, from 1.5 to 4.2, from 1.6 to 4.2, from 1.7 to 4.2, from 1.8 to 4.2, from 1.9 to 4.2, from 2 to 4.2, from 2.1 to 4.2, from 2.2 to 4.2, from 2.3 to 4.2, from 2.4 to 4.2, from 2.5 to 4.2, from 2.6 to 4.2, from 2.7 to 4.2, from 2.8 to 4.2, from 2.9 to 4.2, from 3 to 4.2, from 3.1 to 4.2, from 3.2 to 4.2, from 3.3 to 4.2, from 3.4 to 4.2, from 3.5 to 4.2, from 3.6 to 4.2, from 3.7 to 4.2, from 3.8 to 4.2, from 3.9 to 4.2, from 4 to 4.2, from 1 to 4, from 1.1 to 4, from 1.2 to 4, from 1.3 to 4, from 1.4 to 4, from 1.5 to 4, from 1.6 to 4, from 1.7 to 4, from 1.8 to 4, from 1.9 to 4, from 2 to 4, from 2.1 to 4, from 2.2 to 4, from 2.3 to 4, from 2.4 to 4, from 2.5 to 4, from 2.6 to 4, from 2.7 to 4, from 2.8 to 4, from 2.9 to 4, from 3 to 4, from 3.1 to 4, from 3.2 to 4, from 3.3 to 4, from 3.4 to 4, from 3.5 to 4, from 3.6 to 4, from 3.7 to 4, from 3.8 to 4, from 3.9 to 4, from 1 to 3.9, from 1.1 to 3.9, from 1.2 to 3.9, from 1.3 to 3.9, from 1.4 to 3.9, from 1.5 to 3.9, from 1.6 to 3.9, from 1.7 to 3.9, from 1.8 to 3.9, from 1.9 to 3.9, from 2 to 3.9, from 2.1 to 3.9, from 2.2 to 3.9, from 2.3 to 3.9, from 2.4 to 3.9, from 2.5 to 3.9, from 2.6 to 3.9, from 2.7 to 3.9, from 2.8 to 3.9, from 2.9 to 3.9, from 3 to 3.9, from 3.1 to 3.9, from 3.2 to 3.9, from 3.3 to 3.9, from 3.4 to 3.9, from 3.5 to 3.9, from 3.6 to 3.9, from 3.7 to 3.9, from 3.8 to 3.9, from 1 to 3.8, from 1.1 to 3.8, from 1.2 to 3.8, from 1.3 to 3.8, from 1.4 to 3.8, from 1.5 to 3.8, from 1.6 to 3.8, from 1.7 to 3.8, from 1.8 to 3.8, from 1.9 to 3.8, from 2 to 3.8, from 2.1 to 3.8, from 2.2 to 3.8, from 2.3 to 3.8, from 2.4 to 3.8, from 2.5 to 3.8, from 2.6 to 3.8, from 2.7 to 3.8, from 2.8 to 3.8, from 2.9 to 3.8, from 3 to 3.8, from 3.1 to 3.8, from 3.2 to 3.8, from 3.3 to 3.8, from 3.4 to 3.8, from 3.5 to 3.8, from 3.6 to 3.8, from 3.7 to 3.8, from 1 to 3.7, from 1.1 to 3.7, from 1.2 to 3.7, from 1.3 to 3.7, from 1.4 to 3.7, from 1.5 to 3.7, from 1.6 to 3.7, from 1.7 to 3.7, from 1.8 to 3.7, from 1.9 to 3.7, from 2 to 3.7, from 2.1 to 3.7, from 2.2 to 3.7, from 2.3 to 3.7, from 2.4 to 3.7, from 2.5 to 3.7, from 2.6 to 3.7, from 2.7 to 3.7, from 2.8 to 3.7, from 2.9 to 3.7, from 3 to 3.7, from 3.1 to 3.7, from 3.2 to 3.7, from 3.3 to 3.7, from 3.4 to 3.7, from 3.5 to 3.7, from 3.6 to 3.7, from 1 to 3.6, from 1.1 to 3.6, from 1.2 to 3.6, from 1.3 to 3.6, from 1.4 to 3.6, from 1.5 to 3.6, from 1.6 to 3.6, from 1.7 to 3.6, from 1.8 to 3.6, from 1.9 to 3.6, from 2 to 3.6, from 2.1 to 3.6, from 2.2 to 3.6, from 2.3 to 3.6, from 2.4 to 3.6, from 2.5 to 3.6, from 2.6 to 3.6, from 2.7 to 3.6, from 2.8 to 3.6, from 2.9 to 3.6, from 3 to 3.6, from 3.1 to 3.6, from 3.2 to 3.6, from 3.3 to 3.6, from 3.4 to 3.6, from 3.5 to 3.6, from 1 to 3.5, from 1.1 to 3.5, from 1.2 to 3.5, from 1.3 to 3.5, from 1.4 to 3.5, from 1.5 to 3.5, from 1.6 to 3.5, from 1.7 to 3.5, from 1.8 to 3.5, from 1.9 to 3.5, from 2 to 3.5, from 2.1 to 3.5, from 2.2 to 3.5, from 2.3 to 3.5, from 2.4 to 3.5, from 2.5 to 3.5, from 2.6 to 3.5, from 2.7 to 3.5, from 2.8 to 3.5, from 2.9 to 3.5, from 3 to 3.5, from 3.1 to 3.5, from 3.2 to 3.5, from 3.3 to 3.5, from 3.4 to 3.5, from 1 to 3.4, from 1.1 to 3.4, from 1.2 to 3.4, from 1.3 to 3.4, from 1.4 to 3.4, from 1.5 to 3.4, from 1.6 to 3.4, from 1.7 to 3.4, from 1.8 to 3.4, from 1.9 to 3.4, from 2 to 3.4, from 2.1 to 3.4, from 2.2 to 3.4, from 2.3 to 3.4, from 2.4 to 3.4, from 2.5 to 3.4, from 2.6 to 3.4, from 2.7 to 3.4, from 2.8 to 3.4, from 2.9 to 3.4, from 3 to 3.4, from 3.1 to 3.4, from 3.2 to 3.4, from 3.3 to 3.4, from 1 to 3.3, from 1.1 to 3.3, from 1.2 to 3.3, from 1.3 to 3.3, from 1.4 to 3.3, from 1.5 to 3.3, from 1.6 to 3.3, from 1.7 to 3.3, from 1.8 to 3.3, from 1.9 to 3.3, from 2 to 3.3, from 2.1 to 3.3, from 2.2 to 3.3, from 2.3 to 3.3, from 2.4 to 3.3, from 2.5 to 3.3, from 2.6 to 3.3, from 2.7 to 3.3, from 2.8 to 3.3, from 2.9 to 3.3, from 3 to 3.3, from 3.1 to 3.3, from 3.2 to 3.3, from 1 to 3.2, from 1.1 to 3.2, from 1.2 to 3.2, from 1.3 to 3.2, from 1.4 to 3.2, from 1.5 to 3.2, from 1.6 to 3.2, from 1.7 to 3.2, from 1.8 to 3.2, from 1.9 to 3.2, from 2 to 3.2, from 2.1 to 3.2, from 2.2 to 3.2, from 2.3 to 3.2, from 2.4 to 3.2, from 2.5 to 3.2, from 2.6 to 3.2, from 2.7 to 3.2, from 2.8 to 3.2, from 2.9 to 3.2, from 3 to 3.2, from 3.1 to 3.2, from 1 to 3.1, from 1.1 to 3.1, from 1.2 to 3.1, from 1.3 to 3.1, from 1.4 to 3.1, from 1.5 to 3.1, from 1.6 to 3.1, from 1.7 to 3.1, from 1.8 to 3.1, from 1.9 to 3.1, from 2 to 3.1, from 2.1 to 3.1, from 2.2 to 3.1, from 2.3 to 3.1, from 2.4 to 3.1, from 2.5 to 3.1, from 2.6 to 3.1, from 2.7 to 3.1, from 2.8 to 3.1, from 2.9 to 3.1, from 3 to 3.1, from 1 to 3, from 1.1 to 3, from 1.2 to 3, from 1.3 to 3, from 1.4 to 3, from 1.5 to 3, from 1.6 to 3, from 1.7 to 3, from 1.8 to 3, from 1.9 to 3, from 2 to 3, from 2.1 to 3, from 2.2 to 3, from 2.3 to 3, from 2.4 to 3, from 2.5 to 3, from 2.6 to 3, from 2.7 to 3, from 2.8 to 3, from 2.9 to 3, from 1 to 2.9, from 1.1 to 2.9, from 1.2 to 2.9, from 1.3 to 2.9, from 1.4 to 2.9, from 1.5 to 2.9, from 1.6 to 2.9, from 1.7 to 2.9, from 1.8 to 2.9, from 1.9 to 2.9, from 2 to 2.9, from 2.1 to 2.9, from 2.2 to 2.9, from 2.3 to 2.9, from 2.4 to 2.9, from 2.5 to 2.9, from 2.6 to 2.9, from 2.7 to 2.9, from 2.8 to 2.9, from 1 to 2.8, from 1.1 to 2.8, from 1.2 to 2.8, from 1.3 to 2.8, from 1.4 to 2.8, from 1.5 to 2.8, from 1.6 to 2.8, from 1.7 to 2.8, from 1.8 to 2.8, from 1.9 to 2.8, from 2 to 2.8, from 2.1 to 2.8, from 2.2 to 2.8, from 2.3 to 2.8, from 2.4 to 2.8, from 2.5 to 2.8, from 2.6 to 2.8, from 2.7 to 2.8, from 1 to 2.7, from 1.1 to 2.7, from 1.2 to 2.7, from 1.3 to 2.7, from 1.4 to 2.7, from 1.5 to 2.7, from 1.6 to 2.7, from 1.7 to 2.7, from 1.8 to 2.7, from 1.9 to 2.7, from 2 to 2.7, from 2.1 to 2.7, from 2.2 to 2.7, from 2.3 to 2.7, from 2.4 to 2.7, from 2.5 to 2.7, from 2.6 to 2.7, from 1 to 2.6, from 1.1 to 2.6, from 1.2 to 2.6, from 1.3 to 2.6, from 1.4 to 2.6, from 1.5 to 2.6, from 1.6 to 2.6, from 1.7 to 2.6, from 1.8 to 2.6, from 1.9 to 2.6, from 2 to 2.6, from 2.1 to 2.6, from 2.2 to 2.6, from 2.3 to 2.6, from 2.4 to 2.6, from 2.5 to 2.6, from 1 to 2.5, from 1.1 to 2.5, from 1.2 to 2.5, from 1.3 to 2.5, from 1.4 to 2.5, from 1.5 to 2.5, from 1.6 to 2.5, from 1.7 to 2.5, from 1.8 to 2.5, from 1.9 to 2.5, from 2 to 2.5, from 2.1 to 2.5, from 2.2 to 2.5, from 2.3 to 2.5, from 2.4 to 2.5, from 1 to 2.4, from 1.1 to 2.4, from 1.2 to 2.4, from 1.3 to 2.4, from 1.4 to 2.4, from 1.5 to 2.4, from 1.6 to 2.4, from 1.7 to 2.4, from 1.8 to 2.4, from 1.9 to 2.4, from 2 to 2.4, from 2.1 to 2.4, from 2.2 to 2.4, from 2.3 to 2.4, from 1 to 2.3, from 1.1 to 2.3, from 1.2 to 2.3, from 1.3 to 2.3, from 1.4 to 2.3, from 1.5 to 2.3, from 1.6 to 2.3, from 1.7 to 2.3, from 1.8 to 2.3, from 1.9 to 2.3, from 2 to 2.3, from 2.1 to 2.3, from 2.2 to 2.3, from 1 to 2.2, from 1.1 to 2.2, from 1.2 to 2.2, from 1.3 to 2.2, from 1.4 to 2.2, from 1.5 to 2.2, from 1.6 to 2.2, from 1.7 to 2.2, from 1.8 to 2.2, from 1.9 to 2.2, from 2 to 2.2, from 2.1 to 2.2, from 1 to 2.1, from 1.1 to 2.1, from 1.2 to 2.1, from 1.3 to 2.1, from 1.4 to 2.1, from 1.5 to 2.1, from 1.6 to 2.1, from 1.7 to 2.1, from 1.8 to 2.1, from 1.9 to 2.1, from 2 to 2.1, from 1 to 2, from 1.1 to 2, from 1.2 to 2, from 1.3 to 2, from 1.4 to 2, from 1.5 to 2, from 1.6 to 2, from 1.7 to 2, from 1.8 to 2, from 1.9 to 2, from 1 to 1.9, from 1.1 to 1.9, from 1.2 to 1.9, from 1.3 to 1.9, from 1.4 to 1.9, from 1.5 to 1.9, from 1.6 to 1.9, from 1.7 to 1.9, from 1.8 to 1.9, from 1 to 1.8, from 1.1 to 1.8, from 1.2 to 1.8, from 1.3 to 1.8, from 1.4 to 1.8, from 1.5 to 1.8, from 1.6 to 1.8, from 1.7 to 1.8, from 1 to 1.7, from 1.1 to 1.7, from 1.2 to 1.7, from 1.3 to 1.7, from 1.4 to 1.7, from 1.5 to 1.7, from 1.6 to 1.7, from 1 to 1.6, from 1.1 to 1.6, from 1.2 to 1.6, from 1.3 to 1.6, from 1.4 to 1.6, from 1.5 to 1.6, from 1 to 1.5, from 1.1 to 1.5, from 1.2 to 1.5, from 1.3 to 1.5, from 1.4 to 1.5, from 1 to 1.4, from 1.1 to 1.4, from 1.2 to 1.4, from 1.3 to 1.4, from 1 to 1.3, from 1.1 to 1.3, from 1.2 to 1.3, from 1 to 1.2, from 1.1 to 1.3, or from 1 to 1.1) times the half-life of the radical initiator.

Also provided are embodiments of the processes described above, wherein the process comprises reacting polyisobutylene (such as high-vinylidene polyisobutylene) with a radical initiator and an ethylenically unsaturated acylating agent at a temperature of from 150° C. to 225° C. to produce the reaction product, wherein the polyisobutylene is brought to the reaction temperature in a continuous reactor, prior to commencing continuous addition of the radical initiator to the polyisobutylene in the continuous reactor; and wherein the ethylenically unsaturated acylating agent is added to the continuous reactor: (i) as a mixture with the polyisobutylene; (ii) as a mixture with the radical initiator; and/or (iii) continuously and separately from either the polyisobutylene or the radical initiator.

An illustrative, non-limiting embodiment of the processes described herein may include feeding polyisobutylene into a two- or three-stage reactor system at 170° C., with each stage including an addition of maleic anhydride acylating agent and di-tertbutyl peroxide initiator to the polyisobutylene flowing through the reactor system. With the half-life of di-tertbutyl peroxide being about 6 minutes, each stage is allowed to react for about 20 minutes to allow most of the initiator to be consumed before adding another dose. After two or three stages, in about 40 to 60 minutes, the reaction is complete and the desired reaction product has been achieved.

Also provided are compositions comprising the reaction products described above.

Also provided are compositions comprising reaction products produced by any of the processes described in the various embodiments set forth above.

The subject matter disclosed herein may be better understood with reference to the following examples, which are set forth merely to further illustrate the subject matter disclosed herein. The illustrative examples should not be construed as limiting the subject matter in any manner.

Properties of PIBSAs which are generally characterized include total acid number, free maleic anhydride, percent non-polars, color, and calculated conversion.

Total acid number (“TAN”) is determined by dissolving the sample in toluene and titrating to the thymol blue endpoint with a 0.1 N sodium methoxide solution. Record the volume of titrant needed to maintain the color of the solution as a deep blue for a minimum of 30 seconds; this volume is referred to as the sample titration volume. Acid number (mg KOH/g)=((sample titration volume (mL)−blank titration (mL))*0.1 (the Normality of the sodium methoxide solution)*112.2)/sample mass (g).

Free maleic anhydride (“MAA”), also referred to as unreacted MAA, is determined by weighing a sample of the PIBSA product into a separatory funnel with 100 ml toluene and 50 ml aqueous alcohol solution (prepared by mixing 800 ml of distilled water and 200 ml of isopropyl alcohol). Stopper the separatory funnel and shake to dissolve the sample, venting the funnel as needed. Place the separatory funnel in a steam bath or very hot water to promote phase separation. Drain the lower aqueous phase into an Erlenmeyer flask. Repeat previous procedure two additional times, combining each of the aqueous phases into the same Erlenmeyer flask. Add 5 drops of phenolphthalein indicator to the Erlenmeyer flask and titrate with 0.1 N KOH to the first pink end-point. Free MAA (%) is calculated using the following formula: % free MAA=ml KOH*N KOH*4.90/Sample weight (g)

Percent non-polars (“% non-polars”) is determined by the following method. Prepare a chromatographic column (15 mm inner diameter) by adding about 5 g of silica gel and 1 g of superfiltrol. Add naptha solvent to fill the column. Use a stainless steel spatula to mix the column to remove air bubbles and drain naphtha solvent to ⅛ in above the gel. A sample containing 0.5-0.7 g of PIBSA is dissolved in about 30 ml of naphtha and then poured onto the column. The naphtha effluent is retained in a tared beaker. After completely draining the column, another 30 ml is added and the effluent is drained into the same beaker. This effluent rinse is repeated until about 100 ml is collected in the beaker. The beaker is placed on a steam bath and evaporated to completion. The beaker is placed in a vacuum oven at room temperature for ½ hour minimum. The weight is then measured, the tare weight subtracted, and the grams of residue is thereby obtained. Finally, calculate the % PIBSA activity using the following formula: % PIBSA activity=100−(weight of residue (g)*100)/sample weight (g). % non-polars is equal to 100 minus % PIBSA activity. The result of this test is that the polar PIBSA product sticks to the column, while the non-polar unreacted polyisobutylene (“PIB”) is rinsed through the column with the effluent. Note that in some cases, IR analysis suggests that some polar material is coming off the column with the product, so levels of completely nonpolar unreacted PIB may be artificially inflated.

The calculated conversion is a number that accounts for both the unreacted PIB and unreacted MAA and describes the average number of MAA units per molecule of reacted polymer. PIBSA Conversion=Polymer Mn/(PIBSA Mn−98). Polymer Mn refers to the Mn value obtained via Gel Permeation Chromatography (GPC) analysis of the starting PIB. PIBSA Mn=(112200*(100−% non-polars))/(100/(TAN−(% free MAA*11.45))).

Color of the final PIBSA product is measured by ASTM D 1500.

### Representative Batch Radical Functionalization Reaction Process:

A 12-L round-bottom flask equipped with a Dean-Stark trap, addition funnel, temperature probe, and overhead stirrer was charged with 2300 Mn HV PIB (8000 g). Maleic anhydride (435 g, 1.11 eq) and di-tert-butyl peroxide (16.2 g, 0.028 eq) were independently divided into 6 equal portions in small jars. (Alternatively, MAA and DTBPX can be pre-mixed in a suitable carrier solvent such as acetone and homogenized. This mixture would then be separated into equal portions prior to addition to the reaction flask.) The 2300 Mn PIB was heated to 170° C. and the first portions of maleic anhydride (MAA) and tert-butyl peroxide (DTBPX) were added to the reactor. The reaction mixture was held at 170° C. for 20 minutes before the second portions of MAA and DTBPX were added. The same process was repeated with the remaining 4 portions of MAA and DTBPX over the course of 120 minutes in total. The final molar ratio of PIB:MAA:DTBPX was 1.0:1.11:0.028. Once all 6 additions were completed, the reaction mixture was nitrogen-stripped to remove volatile by-products before it was cooled and poured into a jar.

### Representative Continuous Radical Functionalization Reaction Process:

A continuous reactor system was constructed with three 5 L reaction flasks. Each flask was equipped with a stirrer, a thermocouple probe, a PIB feed port, an MAA feed tube, an initiator feed tube, and an MAA condenser tube. All feed tubes were supra-surface. All MAA condenser tubes were tied together and connected to a nitrogen back pressure bubbler. Ceramic pumps were used to pump PIBSA from flask to flask. Sample valves were included between each flask. 1000 Mn HV PIB was pumped into each flask until about 2,000 g was in each flask. The PIB in the reactor system was heated to 170° C. MAA and di-tert-butyl peroxide were charged into all 3 flasks at 33% each of the total charge of both raw materials. The PIB was pumped at 100 g/min, and the MAA and initiator were pumped at rates to give a final molar ratio of 1.0 PIB:1.0 MAA:0.15 initiator and adjusted throughout the reaction to maintain that stoichiometry. The product of the reaction was pumped into 5-gallon cans.

### Representative Thermal Ene Functionalization Reaction Process:

A 1 L 4-necked, round-bottom flask equipped with an air condenser, air-cooled Friedrich's condenser, thermowell, nitrogen inlet, and a mechanical stirrer was rinsed with 15% nitric acid for 15 minutes. The flask is typically rinsed with DI water, then acetone, then dried thoroughly. After drying, the flask was charged with 1000 Mn high vinylidene polyisobutylene (600.0 g) and MAA (72.8 g). The headspace was purged with nitrogen for 10 minutes, and then a stopper was added to create a back pressure of nitrogen (vented through a bubbler). The reaction was heated to 203° C. under nitrogen while stirring at 450 rpm and held for 24 h. The nitrogen inlet was switched to a subsurface inlet, and the condensers were replaced with two 90° joints to a receiving flask with a cold finger for removing unreacted MAA. The reaction was purged with nitrogen to remove MAA for 2 h. 4.9 g of MAA were collected. The product was cooled to ˜180° C. and poured out into a 1 qt jar (651.6 g, 96.8% yield).

The Examples described below were made via the below-noted Representative Processes described above, with appropriate changes made to account for the particular reaction conditions, reactant properties, and/or other reaction aspects, as described below.

Table 1 below shows a comparison between PIBSAs made via a radical functionalization reaction and PIBSAs made via a thermal ene functionalization reaction on the laboratory scale. Examples 1 and 3 were made via radical functionalization (Example 1 was made by continuous RF and Example 3 was made by batch RF) and Examples 2 and 4 were made via a thermal ene functionalization. Note that reaction time can be greatly reduced, and the product color is much lighter, when using the radical functionalization process compared to the thermal functionalization process, while TAN values are comparable. While the measured values for % non-polar are higher for the products derived from the radical functionalization process, the measured values for the radically functionalized PIB appear to be artificially inflated. Evidence for this artificial inflation of the results can be found by obtaining an IR spectrum of the substance left behind in the beaker used in the test method described above. IR analysis of the filtrate indicates the presence of peaks between 1700 and 1850 wavenumbers, which are indicative of the desired anhydride product. While not wishing to be bound by a particular theory, it is suspected that the radical functionalization may not be exclusively limited to the reaction at the olefin end of the polymer, as functionalization may also occur at other locations along the polymer backbone. Polymers functionalized along the backbone may be less easily adsorbed by the polar media within the column used for separation in the test method described above.

TABLE 1

| | Example 1 | Example 2 | Example 3 | Example 4 |
|---|---|---|---|---|
| PIB Mn; method | 1000 Mn; RF | 1000 Mn; thermal | 2300 Mn; RF | 2300 Mn; thermal |
| # additions | 3 additions | 1 addition | 6 additions | 1 addition |
| Reaction time, hours | 1 hour | 24 hours | 2 hours | 24 hours |
| PIB/MAA/initiator | 1/1.0/0.15 | 1/1.3/0.0 | 1/1.11/0.028 | 1/1.45/0.0 |
| TAN (mg KOH/g) | 105 | 108 | 59 | 47 |
| Free MAA, % | 0.08 | 0.2 | 0.07 | 0.11 |
| Nonpolars, % | 29 | 15 | 32 | 17 |
| Calculated conversion | 1.51 | 1.24 | 1.56 | 1.2 |
| Color | L0.5 | L5.0 | L1.0 | L5.0 |

Examples in Table 2 demonstrate that the radical functionalization process can be successfully conducted via either a batch or a continuous process. Examples 5 and 6 utilized 1300 Mn polyisobutylene as starting material and Examples 3 and 7 utilized 2300 Mn polyisobutylene as starting material.

TABLE 2

| | Example 5 | Example 6 | Example 3 | Example 7 |
|---|---|---|---|---|
| PIB Mn | 1300 | 1300 | 2300 | 2300 |
| Batch or continuous | batch | continuous | batch | continuous |
| Reaction time, hours | 3 hours | 1 hour | 2 hours | 1 hour |
| TAN (mg KOH/g) | 94 | 93 | 58 | 64 |
| PIB/MAA/initiator | 1/1.2/0.1 | | 1/1.11/0.028 | 1/1.47/0.12 |
| Free MAA, % | 0.05 | 0.12 | 0.07 | 0.26 |
| Nonpolars, % | 29 | 30 | 30 | 31 |
| Calculated | 1.72 | 1.71 | 1.56 | 1.96 |
| conversion | | | | |
| Viscosity at 100° C. | 874 | 856 | 2849 | 2755 |
| (cSt) | | | | |

Table 3 includes PIBSA data for a batch radical functionalization reaction between MAA and 500 Mn PIB at two different reaction temperatures. Feed of MAA and initiator was done continuously into the reactor over the period of time indicated in the table below.

TABLE 3

| | Example 8 | Example 9 |
|---|---|---|
| Reaction temp. (° C.) | 170 | 200 |
| Reaction time, hours | 3 | 2 |
| Feed time, hours | 2 | 1.5 |
| TAN (mg KOH/g) | 174 | 177 |
| Free MAA, % | 0.05 | 0.29 |
| Nonpolars, % | 19 | 16 |
| Calculated conversion | 1.17 | 1.43 |

Table 4 shows examples including 1000 Mn PIB with different numbers of feeds of MAA and initiator. Examples 1 and 10 demonstrate that a consistent product can be made whether using two or three feeds of MAA and initiator in a continuous radical functionalization process. Examples 11 and 12 were made using only one MAA and initiator feed. Note that lower TAN numbers and higher viscosity values were achieved in Examples 11 and 12 compared to Examples 1 and 10. The noted increase in viscosity is likely due to formation of polyisobutylene and MAA copolymers as described in U.S. Pat. No. 5,565,528. Example 12 not only uses one dose of MAA and initiator, but also shows the impact of lower reaction temperature on the product obtained. Lower reaction temperatures favor formation of the copolymer of MAA and polyisobutylene.

TABLE 4

| | Example | Example | Example | Example |
|---|---|---|---|---|
| | 1 | 10 | 11 | 12 |
| Feeds | 3 feeds | 2 feeds | 1 feed | 1 feed |
| Reaction temp. (° C.) | 170 | 170 | 190 | 150 |
| Reaction time, min. | 60 | 40 | 15 | 60 |
| PIB/MAA/initiator | 1/1/0.15 | 1/1/0.15 | 1/1/0.5 | 1/1/0.3 |
| TAN (mg KOH/g) | 105 | 102 | 99 | 97 |
| Free MAA | 0.08 | 0.06 | 0.12 | 0.06 |
| Nonpolars % | 29 | 31 | 34 | 31 |
| Calculated | 1.51 | 1.49 | 1.5 | 1.41 |
| conversion | | | | |
| Viscosity at 100° C. | 384 | 414 | 558 | 996 |
| (cSt) | | | | |

Table 5 indicates the impact of initiator concentration and identity on the radical functionalization reaction products using 1000 Mn PIB. Example 1 provides the baseline product made using 0.15 moles of initiator per mol of PIB. Example 13 indicates that lowering the amount of initiator to 0.05 mol % results in a lower TAN product with higher levels of non-polar byproduct. Examples 14, 15, and 16 use different initiators, namely dicumyl peroxide, t-butyl peroxybenzoate, and t-butylperoxy-2-ethylhexanoate, respectively.

TABLE 5

| | Example 1 | Example 13 | Example 14 | Example 15 | Example 16 |
|---|---|---|---|---|---|
| Reaction temp. (° C.) | 170 | 200 | 170 | 170 | 90-100 |
| Reaction time, min | 60 | 30 | 120 | 50 | 360 |
| initiator | DTBPX | DTBPX | dicumyl | TBPB | TBPE |
| PIB/MAA/initiator | 1/1/0.15 | 1/1/0.05 | 1/1/0.2 | 1/1/0.5 | 1/1/0.35 |
| TAN (mg KOH/g) | 105 | 82 | 120 | 98 | 94 |
| Free MAA, % | 0.08 | 0.11 | 0.12 | 0.1 | 0.05 |
| Nonpolars, % | 29 | 44 | 30 | 38 | 29 |
| Calculated conversion | 1.51 | 1.49 | 1.76 | 1.62 | 1.33 |

Dicumyl = dicumyl peroxide
TBPB = t-butyl peroxybenzoate
TBPE = t-butylperoxy-2-ethylhexanoate

The data in Table 6 again shows a viscosity increase that occurs when using 1300 Mn PIB with only one feed of MAA and initiator in a continuous radical functionalization process. Compare Example 17 (one feed) with Example 6 (3 feeds). Example 18 indicates that higher conversion can be obtained when using higher ratios of MAA:PIB.

TABLE 6

| | Example 6 | Example 17 | Example 18 |
|---|---|---|---|
| Feeds | 3 | 1 | 3 |
| Reaction temp. (° C.) | 170 | 170 | 170 |
| Reaction time, min. | 60 | 20 | 60 |
| TAN (mg KOH/g) | 93 | 92 | 128 |
| PIB/MAA/initiator | 1/1.2/0.11 | 1/1.2/0.11 | 1/1.73/0.15 |
| Free MAA, % | 0.12 | 0.43 | 0.56 |
| Nonpolars, % | 30 | 41 | 29 |
| Calculated conversion | 1.71 | 1.96 | 2.33 |
| Viscosity at 100° C. (cSt) | 856 | 1076 | 1733 |

Taken together, the examples presented above demonstrate the successful radical functionalization of PIB to form the desired PIBSA product with a very light color and at greatly reduced reaction times across a variety of PIB Mn reactants under numerous different reaction conditions. The reduced reaction times to create suitable PIBSAs are particularly desirable as this increases the theoretical capacity to make these materials for industrial use. These results show that varying many of the reaction conditions and/or PIB Mn and/or initiator can provide PIBSAs with similar properties which may be desirable for a variety of applications.

Except in the Examples, or where otherwise explicitly indicated or required by context, all numerical quantities in this description specifying amounts of materials, reaction conditions, molecular weights, number of carbon atoms, and the like, are to be understood as modified by the word “about”. As used herein, the term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value. In other embodiments, the value is within a range of the explicitly-described value which would be understood by those of ordinary skill, based on the disclosures provided herein, to perform substantially similarly to compositions including the literal amounts described herein.

It is to be understood that the upper and lower amount, range, and ratio limits set forth herein may be independently combined, and that any amount within a disclosed range is contemplated to provide a minimum or maximum of a narrower range in alternative embodiments (with the proviso, of course, that the minimum amount of a range must be lower than the maximum amount of the same range). Similarly, the ranges and amounts for each element of the subject matter disclosed herein may be used together with ranges or amounts for any of the other elements.

While certain representative embodiments and details have been shown for the purpose of illustrating the subject matter disclosed herein, it will be apparent to those skilled in this art that various changes and modifications may be made therein without departing from the scope of the subject matter. In this regard, the scope of the invention is to be limited only by the following claims.

1. A process for producing a reaction product, the process comprising:
reacting polyisobutylene with a radical initiator and an ethylenically unsaturated acylating agent at a reaction temperature of from 150° C. to 225° C. to produce the reaction product;
wherein the polyisobutylene is brought to the reaction temperature prior to addition of the radical initiator; and
wherein the ethylenically unsaturated acylating agent is added at any time prior to or during addition of the radical initiator.

2. The process of claim 1, wherein the ethylenically unsaturated acylating agent is combined with the polyisobutylene at the beginning of the process.

3. The process of claim 1, wherein the ethylenically unsaturated acylating agent is combined with the radical initiator for addition to the polyisobutylene after the polyisobutylene is brought to the reaction temperature.

4. The process of claim 1, wherein the reaction product comprises less than 15 weight percent of a material comprising two or more polyisobutylene units linked by one or more acylating agent units.

5. The process of claim 1, wherein the polyisobutylene comprises an average of 3 to 56 isobutylene monomeric units per molecule.

6. The process of claim 1, wherein the radical initiator comprises an organic peroxide initiator or a peracid initiator.

7. The process of claim 6, wherein the organic peroxide initiator comprises diglutaroyl, dilauroyl peroxide, benzoyl peroxide, dicumyl peroxide, di(tert butyl) peroxide, tertbutyl hydroperoxide, 3,4-dimethyl-3,4-diphenyl-hexane, tert-butylperoxy-2-ethylhexanoate, tert-butylperoxy-benzoate, tert-butylperoxy-pivalate, tert-butylperoxy-3,5,5-trimethyl-hexanoate, di(2,4-dichlorobenzoyl) peroxide, di(2-methylbenzoyl) peroxide, or di(4-tert-butylcyclohexyl) peroxydicarbonate.

8. The process of claim 1, wherein the ethylenically unsaturated acylating agent comprises maleic acid, fumaric acid, itaconic acid, mesaconic acid, methylenemalonic acid, citraconic acid, maleic anhydride, itaconic anhydride, citraconic anhydride, or methylenemalonic anhydride.

9. The process of claim 1, wherein the reaction product comprises at least one compound of the following general formula I: 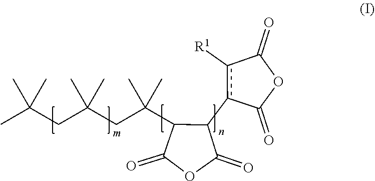
wherein:
each R¹ independently represents: —(CH₂)—(C(CH₂))—(CH₃); H; or is not present; wherein when R¹ is not present, the dashed double bond represents a double bond, and when R¹ is present, the dashed double bond represents a single bond;
each m independently is an integer from 1 to 52; and
each n independently is 0, 1 or 2.

10. The process of claim 1, wherein the reaction product comprises at least 30 mol % of the at least one compound of the general formula I.

11. The process of claim 1, wherein the reaction product comprises less than 40 weight percent unreacted polyisobutylene.

12. A composition comprising the reaction product of the process of claim 1.
